(19) United States
(12) Patent Application Publication
(10) Pub. No.: US 2013/0287093 A1
(43) Pub. Date: Oct. 31, 2013

(54) METHOD AND APPARATUS FOR VIDEO CODING

(71) Applicants: Miska Matias HANNUKSELA, Tampere (FI); Dmytro RUSANOVSKYY, Lempaala (FI)

(72) Inventors: Miska Matias HANNUKSELA, Tampere (FI); Dmytro RUSANOVSKYY, Lempaala (FI)

(73) Assignee: NOKIA CORPORATION, Espoo (FI)

(21) Appl. No.: 13/869,432

(22) Filed: Apr. 24, 2013

Related U.S. Application Data
(60) Provisional application No. 61/637,976, filed on Apr. 25, 2012.

(51) Int. Cl. H04N 7/32

(52) U.S. Cl. CPC H04N 19/00769
USPC 375/240.02

(57) ABSTRACT

There is disclosed a method, apparatus and computer program product in which at least one view component of a first type and at least one view component of a second type are obtained. The order of the texture view component and the depth view component in an access unit is determined and at least one indication of the order is encoded. The coding of the view components is adapted on the basis of the order. There is also disclosed a method, apparatus and computer program product in which at least one encoded view component of a first type and at least one encoded view component of a second type are received. Also at least one encoded indication of the order of the view components is received. The at least one encoded indication is decoded and the decoding of the view components is adapted on the basis of the order.

### TECHNICAL FIELD

The present application relates generally to an apparatus, a method and a computer program for video coding and decoding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

Scalable video coding refers to a coding structure where one bitstream can contain multiple representations of the content at different bitrates, resolutions, frame rates and/or other types of scalability. A scalable bitstream may consist of a base layer providing the lowest quality video available and one or more enhancement layers that enhance the video quality when received and decoded together with the lower layers. In order to improve coding efficiency for the enhancement layers, the coded representation of that layer may depend on the lower layers. Each layer together with all its dependent layers is one representation of the video signal at a certain spatial resolution, temporal resolution, quality level, and/or operation point of other types of scalability.

Various technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

In the encoding of 3D video content, video compression systems, such as Advanced Video Coding standard H.264/AVC or the Multiview Video Coding MVC extension of H.264/AVC can be used.

### SUMMARY

Some embodiments proceed from the consideration that an indication of an order of a texture view component and a depth view component in an access unit can be provided and encoded to a bitstream, and coding of the texture view component and the depth view component may be adapted on the basis of the order of the texture view component and the depth view component.

Various aspects of examples of the invention are provided in the detailed description.

According to a first aspect of the present invention, there is provided a method comprising:
obtaining at least one view component of a first type and at least one view component of a second type of a view;
determining a view component order of the at least one view component of the first type and the at least one view component of the second type in an access unit;
encoding at least one indication of the view component order; and
adapting coding of one or both of the at least one view component of the first type and the at least one view component of the second type on the basis of the view component order.

According to a second aspect of the present invention, there is provided an apparatus comprising at least one processor and at least one memory including computer program code, the at least one memory and the computer program code configured to, with the at least one processor, cause the apparatus to:
obtain at least one view component of a first type and at least one view component of a second type of a view;
determine a view component order of the at least one view component of the first type and the at least one view component of the second type in an access unit;
encode at least one indication of the view component order; and
adapt coding of one or both of the at least one view component of the first type and the at least one view component of the second type on the basis of the view component order.

According to a third aspect of the present invention, there is provided a computer program product including one or more sequences of one or more instructions which, when executed by one or more processors, cause an apparatus to at least perform the following:
obtain at least one view component of a first type and at least one view component of a second type of a view;
determine a view component order of the at least one view component of the first type and the at least one view component of the second type in an access unit;
encode at least one indication of the view component order; and
adapt coding of one or both of the at least one view component of the first type and the at least one view component of the second type on the basis of the view component order.

According to a fourth aspect of the present invention, there is provided an apparatus comprising:
means for obtaining at least one view component of a first type and at least one view component of a second type of a view;
means for determining a view component order of the at least one view component of the first type and the at least one view component of the second type in an access unit;
means for encoding at least one indication of the view component order; and
means for adapting coding of one or both of the at least one view component of the first type and the at least one view component of the second type on the basis of the view component order.

According to a fifth aspect of the present invention, there is provided a method comprising:
receiving at least one encoded view component of a first type and at least one encoded view component of a second type of a view;
receiving at least one encoded indication of a view component order of the at least one view component of the first type and the at least one view component of the second type; and
decoding the at least one encoded indication of the view component order; and
adapting decoding of one or both of the at least one view component of the first type and the at least one view component of the second type on the basis of the view component order.

According to a sixth aspect of the present invention, there is provided an apparatus comprising at least one processor and at least one memory including computer program code, the at least one memory and the computer program code configured to, with the at least one processor, cause the apparatus to:
receive at least one view component of a first type and at least one view component of a second type of a view;
receive at least one encoded indication of a view component order of the at least one view component of the first type and the at least one view component of the second type;
decode the at least one encoded indication of the view component order; and
adapt decoding of one or both of the at least one view component of the first type and the at least one view component of the second type on the basis of the view component order.

According to a seventh aspect of the present invention, there is provided a computer program product including one or more sequences of one or more instructions which, when executed by one or more processors, cause an apparatus to at least perform the following:
receive at least one view component of a first type and at least one view component of a second type of a view;
receive at least one encoded indication of a view component order of the at least one view component of the first type and the at least one view component of the second type;
decode the at least one encoded indication of the view component order; and
adapt decoding of one or both of the at least one view component of the first type and the at least one view component of the second type on the basis of the view component order.

According to an eighth aspect of the present invention, there is provided an apparatus comprising:
means for receiving at least one encoded view component of a first type and at least one encoded view component of a second type of a view;
means for receiving at least one encoded indication of a view component order of the at least one view component of the first type and the at least one view component of the second type; and
means for decoding the at least one encoded indication of the view component order; and
means for adapting decoding of one or both of the at least one view component of the first type and the at least one view component of the second type on the basis of the view component order.

### BRIEF DESCRIPTION OF THE DRAWINGS

For a more complete understanding of example embodiments of the present invention, reference is now made to the following descriptions taken in connection with the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4a shows schematically an embodiment of the invention as incorporated within an encoder;

FIG. 4b shows schematically an embodiment of an inter predictor according to some embodiments of the invention;

FIG. 5 shows a simplified model of a DIBR-based 3DV system;

FIG. 6 shows a simplified 2D model of a stereoscopic camera setup;

FIG. 7 shows an example of definition and coding order of access units;

FIG. 8 shows a high level flow chart of an embodiment of an encoder capable of encoding texture views and depth views;

FIG. 9 shows a high level flow chart of an embodiment of a decoder capable of decoding texture views and depth views;

FIG. 10 shows an example processing flow for depth map coding within an encoder;

FIG. 11 shows an example of coding of two depth map views with in-loop implementation of an encoder;

FIG. 12 shows an example of joint multiview video and depth coding of anchor pictures;

FIG. 13 shows an example of joint multiview video and depth coding of non-anchor pictures;

FIG. 14 depicts a flow chart of an example method for direction separated motion vector prediction;

FIG. 15a shows spatial neighborhood of the currently coded block serving as the candidates for intra prediction;

FIG. 15b shows temporal neighborhood of the currently coded block serving as the candidates for inter prediction;

FIG. 16a depicts a flow chart of an example method of depth-based motion competition for a skip mode in P slices;

FIG. 16b depicts a flow chart of an example method of depth-based motion competition for a direct mode in B slices.

### DETAILED DESCRIPTION OF SOME EXAMPLE EMBODIMENTS

In the following, several embodiments of the invention will be described in the context of one video coding arrangement. It is to be noted, however, that the invention is not limited to this particular arrangement. In fact, the different embodiments have applications widely in any environment where improvement of reference picture handling is required. For example, the invention may be applicable to video coding systems like streaming systems, DVD players, digital television receivers, personal video recorders, systems and computer programs on personal computers, handheld computers and communication devices, as well as network elements such as transcoders and cloud computing arrangements where video data is handled.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

There is a currently ongoing standardization project of High Efficiency Video Coding (HEVC) by the Joint Collaborative Team—Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. In H.264/AVC and HEVC, a picture may either be a frame or a field. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In a draft HEVC standard, video pictures are divided into coding units (CU) covering the area of the picture. A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can further be split into smaller PUs and TUs in order to increase granularity of the prediction and prediction error coding processes, respectively. The PU splitting can be realized by splitting the CU into four equal size square PUs or splitting the CU into two rectangle PUs vertically or horizontally in a symmetric or asymmetric way. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In a draft HEVC standard, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order.

In a Working Draft (WD) 5 of HEVC, some key definitions and concepts for picture partitioning are defined as follows. A partitioning is defined as the division of a set into subsets such that each element of the set is in exactly one of the subsets.

A basic coding unit in a HEVC WD5 is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a HEVC WD5, pictures are divided into slices and tiles. A slice may be a sequence of treeblocks but (when referring to a so-called fine granular slice) may also have its boundary within a treeblock at a location where a transform unit and prediction unit coincide. Treeblocks within a slice are coded and decoded in a raster scan order. For the primary coded picture, the division of each picture into slices is a partitioning.

In a HEVC WD5, a tile is defined as an integer number of treeblocks co-occurring in one column and one row, ordered consecutively in the raster scan within the tile. For the primary coded picture, the division of each picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

A syntax element may be defined as an element of data represented in the bitstream. A syntax structure may be defined as zero or more syntax elements present together in the bitstream in a specified order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit and whether a coded slice contained in the NAL unit is a part of a reference picture or a non-reference picture.

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC standard includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units may additionally contain various indications related to the scalability and multiview hierarchy.

In a draft HEVC standard, a two-byte NAL unit header is used for all specified NAL unit types. The first byte of the NAL unit header contains one reserved bit, a one-bit indication nal_ref_flag primarily indicating whether the picture carried in this access unit is a reference picture or a non-reference picture, and a six-bit NAL unit type indication. The second byte of the NAL unit header includes a three-bit temporal_id indication for temporal level and a five-bit reserved field (called reserved_one_{—}5 bits) required to have a value equal to 1 in a draft HEVC standard. The temporal_id syntax element may be regarded as a temporal identifier for the NAL unit. The five-bit reserved field is expected to be used by extensions such as a future scalable and 3D video extension. It is expected that these five bits would carry information on the scalability hierarchy, such as quality_id or similar, dependency_id or similar, any other type of layer identifier, view order index or similar, view identifier, an identifier similar to priority_id of SVC indicating a valid sub-bitstream extraction if all NAL units greater than a specific identifier value are removed from the bitstream. Without loss of generality, in some example embodiments a variable LayerId is derived from the value of reserved_one_{—}5 bits for example as follows: LayerId=reserved_one_{—}5 bits−1.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU. In H.264/AVC and HEVC a coded slice NAL unit can be indicated to be a coded slice in an Instantaneous Decoding Refresh (IDR) picture or coded slice in a non-IDR picture. In HEVC, a coded slice NAL unit can be indicated to be a coded slice in a Clean Decoding Refresh (CDR) picture (which may also be referred to as a Clean Random Access picture or a CRA picture).

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. A picture parameter set contains such parameters that are likely to be unchanged in several coded pictures.

In a draft HEVC, there is also a third type of parameter sets, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), adaptive sample offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a HEVC standard, a slice header additionally contains an APS identifier. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC. The NAL unit header indicates the type of the NAL unit and whether a coded slice contained in the NAL unit is a part of a reference picture or a non-reference picture.

Many hybrid video codecs, including H.264/AVC and HEVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may also be referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divide a picture into a mesh of rectangles, for each of which a similar block in one of the reference pictures is indicated for inter prediction. The location of the prediction block is coded as a motion vector that indicates the position of the prediction block relative to the block being coded.

Inter prediction process may be characterized using one or more of the following factors.

The Accuracy of Motion Vector Representation.

For example, motion vectors may be of quarter-pixel accuracy, half-pixel accuracy or full-pixel accuracy and sample values in fractional-pixel positions may be obtained using a finite impulse response (FIR) filter.

Block Partitioning for Inter Prediction.

Many coding standards, including H.264/AVC and HEVC, allow selection of the size and shape of the block for which a motion vector is applied for motion-compensated prediction in the encoder, and indicating the selected size and shape in the bitstream so that decoders can reproduce the motion-compensated prediction done in the encoder.

Number of Reference Pictures for Inter Prediction.

The sources of inter prediction are previously decoded pictures. Many coding standards, including H.264/AVC and HEVC, enable storage of multiple reference pictures for inter prediction and selection of the used reference picture on a block basis. For example, reference pictures may be selected on macroblock or macroblock partition basis in H.264/AVC and on PU or CU basis in HEVC. Many coding standards, such as H.264/AVC and HEVC, include syntax structures in the bitstream that enable decoders to create one or more reference picture lists. A reference picture index to a reference picture list may be used to indicate which one of the multiple reference pictures is used for inter prediction for a particular block. A reference picture index may be coded by an encoder into the bitstream is some inter coding modes or it may be derived (by an encoder and a decoder) for example using neighboring blocks in some other inter coding modes.

Motion Vector Prediction.

In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

Multi-Hypothesis Motion-Compensated Prediction.

H.264/AVC and HEVC enable the use of a single prediction block in P slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P slices may be uni-predicted or intra-predicted. The reference pictures for a bi-predictive picture may not be limited to be the subsequent picture and the previous picture in output order, but rather any reference pictures may be used. In many coding standards, such as H.264/AVC and HEVC, one reference picture list, referred to as reference picture list 0, is constructed for P slices, and two reference picture lists, list 0 and list 1, are constructed for B slices. For B slices, when prediction in forward direction may refer to prediction from a reference picture in reference picture list 0, and prediction in backward direction may refer to prediction from a reference picture in reference picture list 1, even though the reference pictures for prediction may have any decoding or output order relation to each other or to the current picture.

Weighted Prediction.

Many coding standards use a prediction weight of 1 for prediction blocks of inter (P) pictures and 0.5 for each prediction block of a B picture (resulting into averaging). H.264/AVC allows weighted prediction for both P and B slices. In implicit weighted prediction, the weights are proportional to picture order counts, while in explicit weighted prediction, prediction weights are explicitly indicated.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

In a draft HEVC, each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the TU (including e.g. DCT coefficient information). It may be signalled at CU level whether prediction error coding is applied or not for each CU. In the case there is no prediction error residual associated with the CU, it can be considered there are no TUs for the CU.

In some coding formats and codecs, a distinction is made between so-called short-term and long-term reference pictures. This distinction may affect some decoding processes such as motion vector scaling in the temporal direct mode or implicit weighted prediction. If both of the reference pictures used for the temporal direct mode are short-term reference pictures, the motion vector used in the prediction may be scaled according to the picture order count (POC) difference between the current picture and each of the reference pictures. However, if at least one reference picture for the temporal direct mode is a long-term reference picture, default scaling of the motion vector may be used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, a default prediction weight may be used, such as 0.5 in implicit weighted prediction for bi-predicted blocks.

Some video coding formats, such as H.264/AVC, include the frame_num syntax element, which is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices, for implicitly derived weights in weighted prediction, and for reference picture list initialization. Furthermore, POC may be used in the verification of output order conformance. In H.264/AVC, POC is specified relative to the previous IDR picture or a picture containing a memory management control operation marking all pictures as “unused for reference”.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in HEVC, a combined list (List C) is constructed after the final reference picture lists (List 0 and List 1) have been constructed. The combined list may be used for uni-prediction (also known as uni-directional prediction) within B slices.

A reference picture list, such as reference picture list 0 and reference picture list 1, is typically constructed in two steps: First, an initial reference picture list is generated. The initial reference picture list may be generated for example on the basis of frame_num, POC, temporal_id, or information on the prediction hierarchy such as GOP structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

The combined list in HEVC may be constructed as follows. If the modification flag for the combined list is zero, the combined list is constructed by an implicit mechanism; otherwise it is constructed by reference picture combination commands included in the bitstream. In the implicit mechanism, reference pictures in List C are mapped to reference pictures from List 0 and List 1 in an interleaved fashion starting from the first entry of List 0, followed by the first entry of List 1 and so forth. Any reference picture that has already been mapped in List C is not mapped again. In the explicit mechanism, the number of entries in List C is signaled, followed by the mapping from an entry in List 0 or List 1 to each entry of List C. In addition, when List 0 and List 1 are identical the encoder has the option of setting the ref_pic_list_combination_flag to 0 to indicate that no reference pictures from List 1 are mapped, and that List C is equivalent to List 0. Typical high efficiency video codecs such as a draft HEVC codec employ an additional motion information coding/decoding mechanism, often called merging/merge mode/process/mechanism, where all the motion information of a block/PU is predicted and used without any modification/correction. The aforementioned motion information for a PU comprises 1) The information whether ‘the PU is uni-predicted using only reference picture list0’ or ‘the PU is uni-predicted using only reference picture list 1’ or ‘the PU is bi-predicted using both reference picture list0 and list 1’ 2) Motion vector value corresponding to the reference picture list0 3) Reference picture index in the reference picture list0 4) Motion vector value corresponding to the reference picture list1 5) Reference picture index in the reference picture list 1. Similarly, predicting the motion information is carried out using the motion information of adjacent blocks and/or co-located blocks in temporal reference pictures. Typically, a list, often called as a merge list, is constructed by including motion prediction candidates associated with available adjacent/co-located blocks and the index of selected motion prediction candidate in the list is signalled. Then the motion information of the selected candidate is copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism is also employed for individual PUs (not necessarily the whole CU as in skip mode) and in this case, prediction residual may be utilized to improve prediction quality. This type of prediction mode is typically named as an inter-merge mode.

A syntax structure for decoded reference picture marking may exist in a video coding system. For example, when the decoding of the picture has been completed, the decoded reference picture marking syntax structure, if present, may be used to adaptively mark pictures as “unused for reference” or “used for long-term reference”. If the decoded reference picture marking syntax structure is not present and the number of pictures marked as “used for reference” can no longer increase, a sliding window reference picture marking may be used, which basically marks the earliest (in decoding order) decoded reference picture as unused for reference.

Scalable video coding refers to a coding structure where one bitstream can contain multiple representations of the content at different bitrates, resolutions and/or frame rates. In these cases the receiver can extract the desired representation depending on its characteristics (e.g. resolution that matches best with the resolution of the display of the device). Alternatively, a server or a network element can extract the portions of the bitstream to be transmitted to the receiver depending on e.g. the network characteristics or processing capabilities of the receiver.

A scalable bitstream may consist of a base layer providing the lowest quality video available and one or more enhancement layers that enhance the video quality when received and decoded together with the lower layers. An enhancement layer may enhance the temporal resolution (i.e., the frame rate), the spatial resolution, or simply the quality of the video content represented by another layer or part thereof. In order to improve coding efficiency for the enhancement layers, the coded representation of that layer may depend on the lower layers. For example, the motion and mode information of the enhancement layer can be predicted from lower layers. Similarly the pixel data of the lower layers can be used to create prediction for the enhancement layer(s).

Each scalable layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop is needed for decoding of most pictures, while a second decoding loop is selectively applied to reconstruct the base representations, which are needed as prediction references but not for output or display, and are reconstructed only for the so called key pictures (for which “store_ref_base_pic_flag” is equal to 1).

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL-1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref_base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_refactive_{—}1x_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

In an H.264/AVC bit stream, coded pictures in one coded video sequence uses the same sequence parameter set, and at any time instance during the decoding process, only one sequence parameter set is active. In SVC, coded pictures from different scalable layers may use different sequence parameter sets. If different sequence parameter sets are used, then, at any time instant during the decoding process, there may be more than one active sequence picture parameter set. In the SVC specification, the one for the top layer is denoted as the active sequence picture parameter set, while the rest are referred to as layer active sequence picture parameter sets. Any given active sequence parameter set remains unchanged throughout a coded video sequence in the layer in which the active sequence parameter set is referred to.

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded.

As indicated earlier, MVC is an extension of H.264/AVC. Many of the definitions, concepts, syntax structures, semantics, and decoding processes of H.264/AVC apply also to MVC as such or with certain generalizations or constraints. Some definitions, concepts, syntax structures, semantics, and decoding processes of MVC are described in the following.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit results in one decoded picture consisting of one or more decoded view components, when decoding errors, bitstream errors or other errors which may affect the decoding do not occur. In other words, an access unit in MVC contains the view components of the views for one output time instance.

A view component in MVC is referred to as a coded representation of a view in a single access unit.

Inter-view prediction may be used in MVC and refers to prediction of a view component from decoded samples of different view components of the same access unit. In MVC, inter-view prediction is realized similarly to inter prediction. For example, inter-view reference pictures are placed in the same reference picture list(s) as reference pictures for inter prediction, and a reference index as well as a motion vector are coded or inferred similarly for inter-view and inter reference pictures.

An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

In MVC, coded pictures from different views may use different sequence parameter sets. An SPS in MVC can contain the view dependency information for inter-view prediction. This may be used for example by signaling-aware media gateways to construct the view dependency tree.

In the context of multiview video coding, view order index may be defined as an index that indicates the decoding or bitstream order of view components in an access unit. In MVC, the inter-view dependency relationships are indicated in a sequence parameter set MVC extension, which is included in a sequence parameter set. According to the MVC standard, all sequence parameter set MVC extensions that are referred to by a coded video sequence are required to be identical. The following excerpt of the sequence parameter set MVC extension provides further details on the way inter-view dependency relationships are indicated in MVC.

| | | | De- |
|---|---|---|---|
| | | | scrip- |
| seq_parameter_set_mvc_extension( ) { | | C | tor |
| | num_views_minus1 | 0 | ue(v) |
| | for( i = 0; i <= num_views_minus1; i++ ) | | |

| | | |
|---|---|---|
| view_id[ i ] | 0 | ue(v) |

for( i = 1; i <= num_views_minus1; i++ ) {

| | | |
|---|---|---|
| num_anchor_refs_l0[ i ] | 0 | ue(v) |
| for( j = 0; j < num_anchor_refs_l0[ i ]; j++ ) | | |
| anchor_ref_l0[ i ][ j ] | 0 | ue(v) |
| num_anchor_refs_l1[ i ] | 0 | ue(v) |
| for( j = 0; j < num_anchor_refs_l1[ i ]; j++ ) | | |
| anchor_ref_l1[ i ][ j ] | 0 | ue(v) |

}
for( i = 1; i <= num_views_minus1; i++ ) {

| | | |
|---|---|---|
| num_non_anchor_refs_l0[ i ] | 0 | ue(v) |
| for( j = 0; j < num_non_anchor_refs_l0[ i ]; j++ ) | | |
| non_anchor_ref_l0[ i ][ j ] | 0 | ue(v) |
| num_non_anchor_refs_l1[ i ] | 0 | ue(v) |
| for( j = 0; j < num_non_anchor_refs_l1[ i ]; j++ ) | | |
| non_anchor_ref_l1[ i ][ j ] | 0 | ue(v) |

}
...

In MVC decoding process, the variable VOIdx may represent the view order index of the view identified by view_id (which may be obtained from the MVC NAL unit header of the coded slice being decoded) and may be set equal to the value of i for which the syntax element view_id[i] included in the referred subset sequence parameter set is equal to view_id.

The semantics of the sequence parameter set MVC extension may be specified as follows. num_views_minus1 plus 1 specifies the maximum number of coded views in the coded video sequence. The actual number of views in the coded video sequence may be less than num_views_minus1 plus 1. view_id[i] specifies the view_id of the view with VOIdx equal to i. num_anchor_refs_l0[i] specifies the number of view components for inter-view prediction in the initial reference picture list RefPicList0 in decoding anchor view components with VOIdx equal to i. anchor_ref_l0[i][j] specifies the view_id of the j-th view component for inter-view prediction in the initial reference picture list RefPicList0 in decoding anchor view components with VOIdx equal to i. num_anchor_refs_l1[i] specifies the number of view components for inter-view prediction in the initial reference picture list RefPicList1 in decoding anchor view components with VOIdx equal to i. anchor_ref_l1[i][j] specifies the view_id of the j-th view component for inter-view prediction in the initial reference picture list RefPicList1 in decoding an anchor view component with VOIdx equal to i. num_non_anchor_refs_l0[i] specifies the number of view components for inter-view prediction in the initial reference picture list RefPicList0 in decoding non-anchor view components with VOIdx equal to i. non_anchor_ref_l0[i][j] specifies the view_id of the j-th view component for inter-view prediction in the initial reference picture list RefPicList0 in decoding non-anchor view components with VOIdx equal to i. num_non_anchor_refs_l1[i] specifies the number of view components for inter-view prediction in the initial reference picture list RefPicList1 in decoding non-anchor view components with VOIdx equal to i. non_anchor_ref_l1[i][j] specifies the view_id of the j-th view component for inter-view prediction in the initial reference picture list RefPicList1 in decoding non-anchor view components with VOIdx equal to i. For any particular view with view_id equal to vId1 and VOIdx equal to vOIdx1 and another view with view_id equal to vId2 and VOIdx equal to vOIdx2, when vId2 is equal to the value of one of non_anchor_ref_l0[vOIdx1][j] for all j in the range of 0 to num_non_anchor_refs_l0[vOIdx1], exclusive, or one of non_anchor_ref_l1[vOIdx1][j] for all j in the range of 0 to num_non_anchor_refs_l1[vOIdx1], exclusive, vId2 is also required to be equal to the value of one of anchor_ref_l0[vOIdx1][j] for all j in the range of 0 to num_anchor_refs_l0[vOIdx1], exclusive, or one of anchor_ref_l1[vOIdx1][j] for all j in the range of 0 to num_anchor_refs_l1[vOIdx1], exclusive. The inter-view dependency for non-anchor view components is a subset of that for anchor view components.

In scalable multiview coding, the same bitstream may contain coded view components of multiple views and at least some coded view components may be coded using quality and/or spatial scalability.

A texture view refers to a view that represents ordinary video content, for example has been captured using an ordinary camera, and is usually suitable for rendering on a display. A texture view typically comprises pictures having three components, one luma component and two chroma components. In the following, a texture picture typically comprises all its component pictures or color components unless otherwise indicated for example with terms luma texture picture and chroma texture picture.

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

A texture view component may be defined as a coded representation of the texture of a view in a single access unit. A texture view component in depth-enhanced video bitstream may be coded in a manner that is compatible with a single-view texture bitstream or a multi-view texture bitstream so that a single-view or multi-view decoder can decode the texture views even if it has no capability to decode depth views. For example, an H.264/AVC decoder may decode a single texture view from a depth-enhanced H.264/AVC bitstream. A texture view component may alternatively be coded in a manner that a decoder capable of single-view or multi-view texture decoding, such H.264/AVC or MVC decoder, is not able to decode the texture view component for example because it uses depth-based coding tools. A depth view component may be defined as a coded representation of the depth of a view in a single access unit. A view component pair may be defined as a texture view component and a depth view component of the same view within the same access unit.

Depth-enhanced video may be coded in a manner where texture and depth are coded independently of each other. For example, texture views may be coded as one MVC bitstream and depth views may be coded as another MVC bitstream. Depth-enhanced video may also be coded in a manner where texture and depth are jointly coded. When joint coding texture and depth views is applied for a depth-enhanced video representation, some decoded samples of a texture picture or data elements for decoding of a texture picture are predicted or derived from some decoded samples of a depth picture or data elements obtained in the decoding process of a depth picture. Alternatively or in addition, some decoded samples of a depth picture or data elements for decoding of a depth picture are predicted or derived from some decoded samples of a texture picture or data elements obtained in the decoding process of a texture picture. In another option, coded video data of texture and coded video data of depth are not predicted from each other or one is not coded/decoded on the basis of the other one, but coded texture and depth view may be multiplexed into the same bitstream in the encoding and demultiplexed from the bitstream in the decoding. In yet another option, while coded video data of texture is not predicted from coded video data of depth in e.g. below slice layer, some of the high-level coding structures of texture views and depth views may be shared or predicted from each other. For example, a slice header of coded depth slice may be predicted from a slice header of a coded texture slice. Moreover, some of the parameter sets may be used by both coded texture views and coded depth views.

It has been found that a solution for some multiview 3D video (3DV) applications is to have a limited number of input views, e.g. a mono or a stereo view plus some supplementary data, and to render (i.e. synthesize) all required views locally at the decoder side. From several available technologies for view rendering, depth image-based rendering (DIBR) has shown to be a competitive alternative.

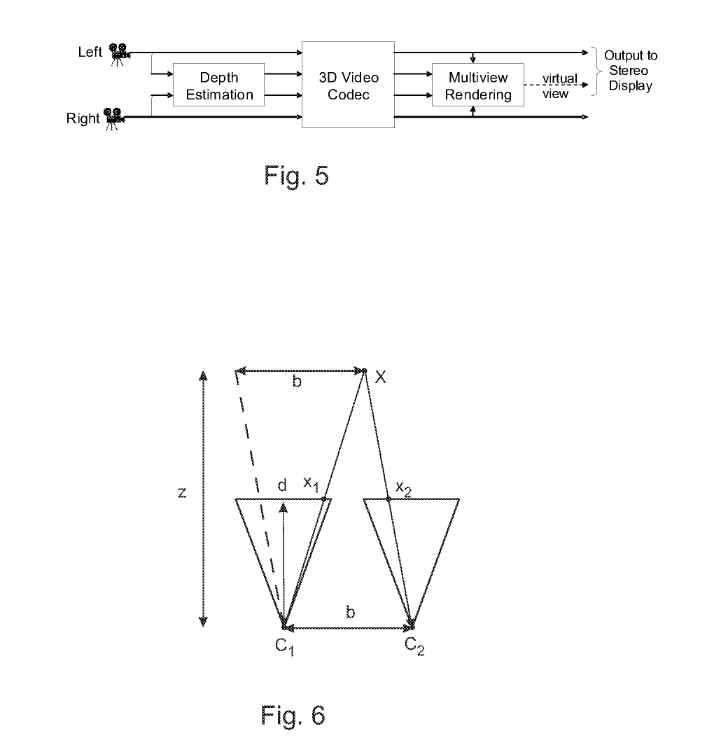

A simplified model of a DIBR-based 3DV system is shown in FIG. 5. The input of a 3D video codec comprises a stereoscopic video and corresponding depth information with stereoscopic baseline b0. Then the 3D video codec synthesizes a number of virtual views between two input views with baseline (bi<b0). DIBR algorithms may also enable extrapolation of views that are outside the two input views and not in between them. Similarly, DIBR algorithms may enable view synthesis from a single view of texture and the respective depth view. However, in order to enable DIBR-based multiview rendering, texture data should be available at the decoder side along with the corresponding depth data.

In such 3DV system, depth information is produced at the encoder side in a form of depth pictures (also known as depth maps) for each video frame. A depth map is an image with per-pixel depth information. Each sample in a depth map represents the distance of the respective texture sample from the plane on which the camera lies. In other words, if the z axis is along the shooting axis of the cameras (and hence orthogonal to the plane on which the cameras lie), a sample in a depth map represents the value on the z axis.

Depth information can be obtained by various means. For example, depth of the 3D scene may be computed from the disparity registered by capturing cameras. A depth estimation algorithm takes a stereoscopic view as an input and computes local disparities between the two offset images of the view. Each image is processed pixel by pixel in overlapping blocks, and for each block of pixels a horizontally localized search for a matching block in the offset image is performed. Once a pixel-wise disparity is computed, the corresponding depth value z is calculated by equation (1):

$$z = \frac{f \cdot b}{d + Δ d} , \qquad ( 1 )$$

where f is the focal length of the camera and b is the baseline distance between cameras, as shown in FIG. 6. Further, d refers to the disparity observed between the two cameras, and the camera offset Δd reflects a possible horizontal misplacement of the optical centers of the two cameras. However, since the algorithm is based on block matching, the quality of a depth-through-disparity estimation is content dependent and very often not accurate. For example, no straightforward solution for depth estimation is possible for image fragments that are featuring very smooth areas with no textures or large level of noise.

Disparity or parallax maps, such as parallax maps specified in ISO/IEC International Standard 23002-3, may be processed similarly to depth maps. Depth and disparity have a straightforward correspondence and they can be computed from each other through mathematical equation.

Texture views and depth views may be coded into a single bitstream where some of the texture views may be compatible with one or more video standards such as H.264/AVC and/or MVC. In other words, a decoder may be able to decode some of the texture views of such a bitstream and can omit the remaining texture views and depth views.

In this context an encoder that encodes one or more texture and depth views into a single H.264/AVC and/or MVC compatible bitstream is also called as a 3DV-ATM encoder. Bitstreams generated by such an encoder can be referred to as 3DV-ATM bitstreams. The 3DV-ATM bitstreams may include some of the texture views that H.264/AVC and/or MVC decoder cannot decode, and depth views. A decoder capable of decoding all views from 3DV-ATM bitstreams may also be called as a 3DV-ATM decoder.

3DV-ATM bitstreams can include a selected number of AVC/MVC compatible texture views. The depth views for the AVC/MVC compatible texture views may be predicted from the texture views. The remaining texture views may utilize enhanced texture coding and depth views may utilize depth coding.

An example of syntax and semantics of a 3DV-ATM bitstream and a decoding process for a 3DV-ATM bitstream may be found in document MPEG N12544, “Working Draft 2 of MVC extension for inclusion of depth maps”, which requires at least two texture views to be MVC compatible. An example of syntax and semantics of a 3DV-ATM bitstream and a decoding process for a 3DV-ATM bitstream may be found in document MPEG N12545, “Working Draft 1 of AVC compatible video with depth information”, which requires at least one texture view to be AVC compatible and further texture views may be MVC compatible. The bitstream formats and decoding processes specified in the mentioned documents are compatible as described in the following. The 3DV-ATM configuration corresponding to the working draft of “MVC extension for inclusion of depth maps” (MPEG N12544) may be referred to as “3D High”. The 3DV-ATM configuration corresponding to the working draft of “AVC compatible video with depth information” (MPEG N12545) may be referred to as “3D Extended High” or “3D Enhanced High”. The 3D Extended High configuration is a superset of the 3D High configuration. That is, a decoder supporting 3D Extended High configuration should also be able to decode bitstreams generated for the 3D High configuration.

In 3DV-ATM as specified in documents MPEG N12544 and N12545, the inter-view dependency order is identical among the depth views compared to that among the texture views, i.e. the contents of the sequence parameter set MVC extension of all active sequence parameter sets is the same. Furthermore, in 3DV-ATM the view order index indicates the decoding order of texture or depth view components in an access unit, but does not indicate the decoding order of texture view components relative to depth view components.

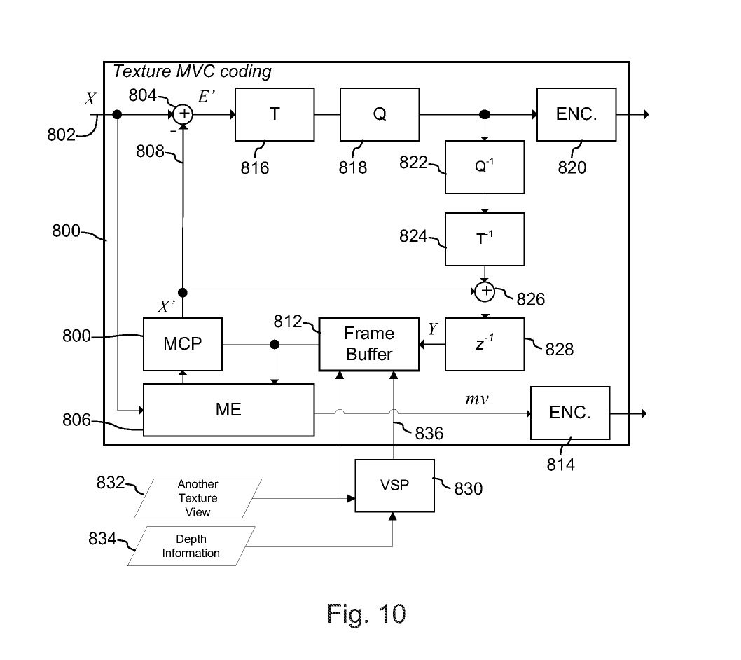

FIG. 10 shows an example processing flow for depth map coding for example in 3DV-ATM.

Depth maps may be filtered jointly for example using in-loop Joint inter-View Depth Filtering (JVDF) described as follows. The depth map of the currently processed view V, may be converted into the depth space (Z-space):

$$z = \frac{1}{\frac{{v}_{1}}{255} \cdot ( \frac{1}{Z {1}_{near}} - \frac{1}{Z {1}_{far}} ) + \frac{1}{Z {1}_{far}}}$$

Following this, depth map images of other available views (Vₐ₁, Vₐ₂) may be converted to the depth space and projected to the currently processed view V_{c}. These projections create several estimates of the depth value, which may be averaged in order to produce a denoised estimate of the depth value. Filtered depth value \hat{z}_{c} of current view V_{c} may be produced through a weighted average with depth estimate values \hat{z}_{a->c} projected from an available views Vₐ to a currently processed view V_{c}.

\hat{z}_{c}=w₁·z_{c}+w₂·z_{a->c}

where {w₁, w₂} are weighting factors or filter coefficients for the depth values of different views or view projections.

Filtering may be applied if depth value estimates belong to a certain confidence interval, in other words, if the absolute difference between estimates is below a particular threshold (Th):

If |z_{a→c}−z_{c}|<Th, w₁=w₂=0.5
Otherwise, w₁=1, w₂=0

Parameter Th may be transmitted to the decoder for example within a sequence parameter set.

FIG. 11 shows an example of the coding of two depth map views with in-loop implementation of JVDF. A conventional video coding algorithm, such as H.264/AVC, is depicted within a dashed line box 1100, marked in black color. The JVDF is depicted in the solid-line box 1102.

In a coding tool known as joint multiview video plus depth coding (JMVDC), the correlation between the multiview texture video and the associated depth view sequences is exploited. Although the pixel values are quite different between a texture video and its depth map sequence, the silhouettes and movements of the objects in the texture video and the associated depth map sequence are typically similar. The proposed JMVDC scheme may be realized by a combination of the MVC and SVC coding schemes. Specifically, JMVDC may be realized by embedding the inter-layer motion prediction mechanism of SVC into the prediction structure in MVC. Each view may be coded and/or regarded as of a two-layer representation, where the texture resides in the base layer and the depth in the enhancement layer, which may be coded using the coarse granular scalability (CGS) of SVC with only inter-layer motion prediction allowed. In addition, inter-view prediction is enabled both in the base layer (texture) and in the enhancement layer (depth) for non-base views. While the inter-layer motion prediction of JMVDC could be applied for any inter-view prediction structure used for the base layer, an encoder and decoder may be realized in such a manner that inter-view prediction only appears at IDR and anchor access units, as it may provide a reasonable compromise between complexity and compression efficiency and ease the implementation effort of JMVDC. In the following, the JMVDC scheme is described for the IDR/anchor and non-anchor access units when inter-view prediction is allowed only in IDR/anchor access units and disallowed in non-IDR/non-anchor access units.

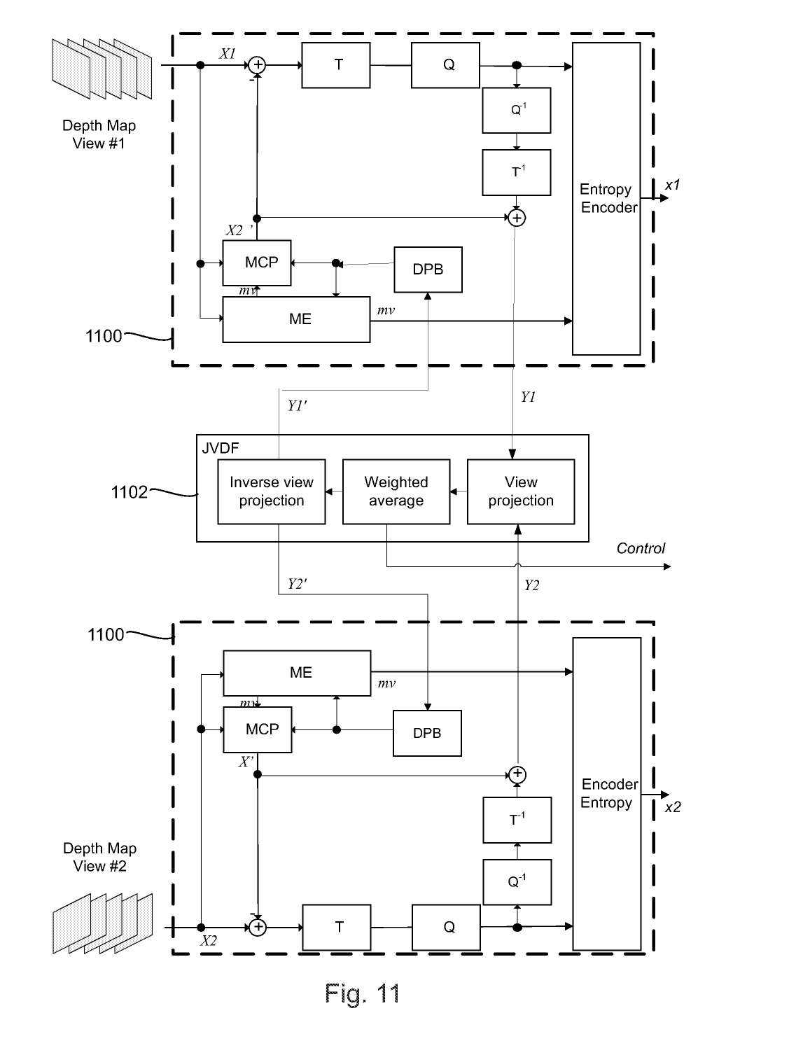

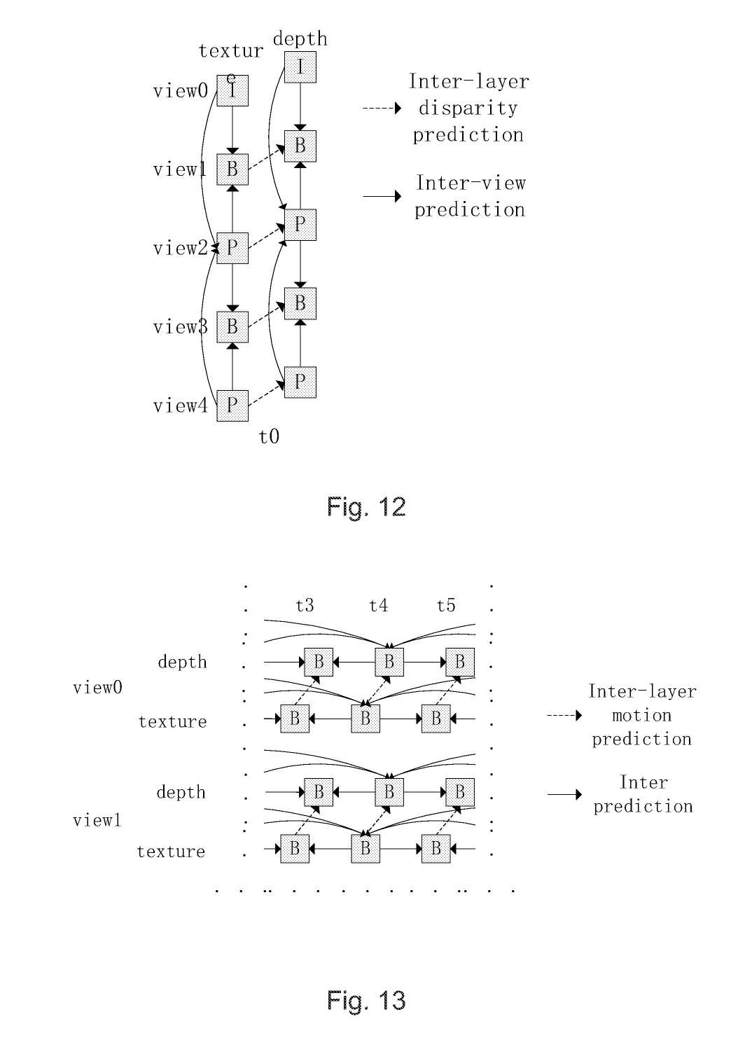

For IDR and anchor pictures, the JMVDC scheme may be applied as follows. A motion vector used in the inter-view prediction is called a disparity vector. As illustrated in FIG. 12, the disparity vectors of the multiview texture video are used as a prediction reference for derivation of the disparity vectors of multiview depth map in the inter-layer motion prediction process. In an example coding scheme, this prediction mechanism is referred as the inter-layer disparity prediction. For the coding of non-IDR/non-anchor pictures in JMVDC, the depth motion vectors for inter prediction may be predicted using the inter-layer motion prediction process from the respective texture motion vectors as depicted in FIG. 13.

The mode decision process for enhancement layer macroblocks may be identical for both anchor pictures and non-anchor pictures. The base mode may be added to the mode decision process and the motion/disparity vector of the co-located macroblock in the base layer may be chosen as a motion/disparity vector predictor for each enhancement layer macroblock.

The JMVDC tool may also be used in an arrangement where a depth view is regarded as the base layer and the respective texture view as the enhancement layer, and coding and decoding may be done otherwise as described above.

A coding tool known as inside-view motion prediction (IVMP) may operate as follows. In IVMP mode, the motion information, including mb_type, sub_mb_type, reference indices and motion vectors of the co-located macroblock in texture view component may be reused by the depth view component of the same view. A flag may be signaled in each macroblock or macroblock partition to indicate whether it uses the IVMP mode. If the spatial resolution of the depth view component differs from that of the texture view component, the motion vectors of the depth view components may be scaled proportionally to the ratio between the spatial resolutions of the texture view component and the depth view component, when they are used as the motion vectors of the co-located block or macroblock of the texture view component.

In-loop View Synthesis Prediction (VSP) may be performed as follows. View synthesis may be implemented through depth map (d) to disparity (D) conversion with following mapping pixels of source picture s(x,y) in a new pixel location in synthesised target image t(x+D,y).

$$t ( ⌊ x + D ⌋ , y ) = s ( x , y ) , \\ D ( s ( x , y ) ) = \frac{f \cdot l}{z}$$

$$z = {( \frac{d ( s ( x , y ) )}{255} ( \frac{1}{{Z}_{near}} - \frac{1}{{Z}_{far}} ) + \frac{1}{{Z}_{far}} )}^{- 1} .$$

In the case of projection of texture picture, s(x,y) is a sample of texture image, and d(s(x,y)) is the depth map value associated with s(x,y).

If a reference frame used for synthesis is 4:2:0, the chroma components may be upsampled to 4:4:4 for example by repeating the sample values as follows:

s′_{chroma}(x,y)=s_{chroma}(⊙x/2┘,⊙y/2┘)

where s′_{chroma}(•,•) is the chroma sample value in full resolution, and s_{chroma}(•,•) is the chroma sample value in half resolution.

In the case of projection of depth map values, s(x,y)=d(x,y) and this sample is projected using its own value d(s(x,y))=d(x,y).

Warping may be performed at sub-pixel accuracy by upsampling on the reference frame before warping and downsampling the synthesized frame back to the original resolution.

The view synthesis process may comprise two conceptual steps: forward warping and hole filling. In forward warping, each pixel of the reference image is mapped to a synthesized image. When multiple pixels from reference frame are mapped to the same sample location in the synthesized view, the pixel associated with a larger depth value (closer to the camera) may be selected in the mapping competition. After warping all pixels, there may be some hole pixels left with no sample values mapped from the reference frame, and these hole pixels may be filled in for example with a line-based directional hole filling, in which a “hole” is defined as consecutive hole pixels in a horizontal line between two non-hole pixels. Hole pixels may be filled by one of the two adjacent non-hole pixels which have a smaller depth sample value (farther from the camera).

A synthesized picture resulting from VSP may be included in the initial reference picture lists List0 and List1 for example following temporal and inter-view reference frames. However, reference picture list modification syntax (i.e., RPLR commands) may be extended to support VSP reference pictures, thus the encoder can order reference picture lists at any order, indicate the final order with RPLR commands in the bitstream, causing the decoder to reconstruct the reference picture lists having the same final order.

VSP may also be used in some encoding and decoding arrangements as a separate mode from intra, inter, inter-view and other coding modes. For example, no motion vector difference may be encoded into the bitstream for a block using VSP skip/direct mode, but the encoder and decoder may infer the motion vector difference to be equal to 0 and/or the motion vector being equal to 0. Furthermore, the VSP skip/direct mode may infer that no transform-coded residual block is encoded for the block using VSP skip/direct mode.

Depth-based motion vector prediction (D-MVP) is a coding tool which takes in use available depth map data and utilizes it for coding/decoding of the associated depth map texture data. This coding tool may require depth view component of a view to be coded/decoded prior to the texture view component of the same view. The D-MVP tool may comprise two parts, direction-separated MVP and depth-based MV competition for Skip and Direct modes, which are described next.

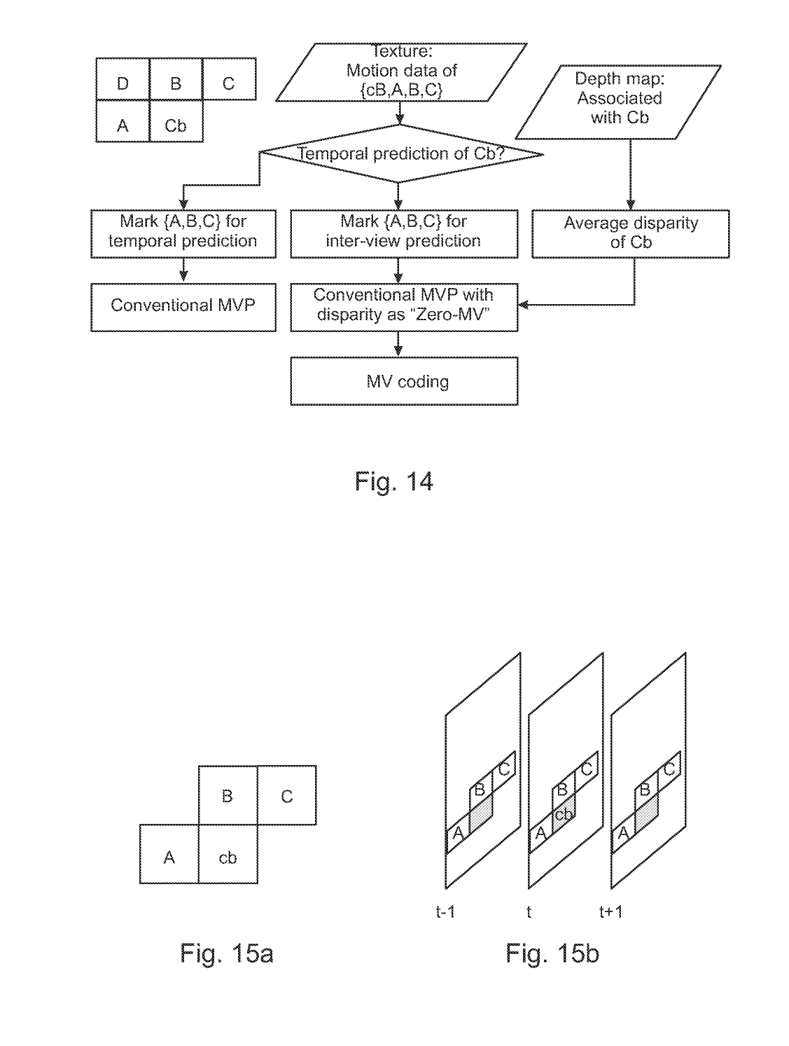

Direction-separated MVP may be described as follows. All available neighboring blocks are classified according to the direction of their prediction (e.g. temporal, inter-view, and view synthesis prediction). If the current block Cb, see FIG. 15a, uses an inter-view reference picture, all neighboring blocks which do not utilize inter-view prediction are marked as not-available for MVP and are not considered in the conventional motion vector prediction, such as the MVP of H.264/AVC. Similarly, if the current block Cb uses temporal prediction, neighboring blocks that used inter-view reference frames are marked as not-available for MVP. The flowchart of this process is depicted in FIG. 14. The flowchart and the description below considers temporal and inter-view prediction directions only, but it could be similarly extended to cover also other prediction directions, such as view synthesis prediction, or one or both of temporal and inter-view prediction directions could be similarly replaced by other prediction directions.

If no motion vector candidates are available from the neighboring blocks, the default “zero-MV” MVP (mv_{y}=0, mvₓ=0) for inter-view prediction may be replaced with mv_{y}=0 and mvₓ= ^{D̅(cb)}, where D̅(cb) is average disparity which is associated with current texture Cb and may be computed by:

D̅(cb)=(1/N)·ΣᵢD(cb(i))

where i is index of pixels within current block Cb, N is a total number of pixels in the current block Cb.

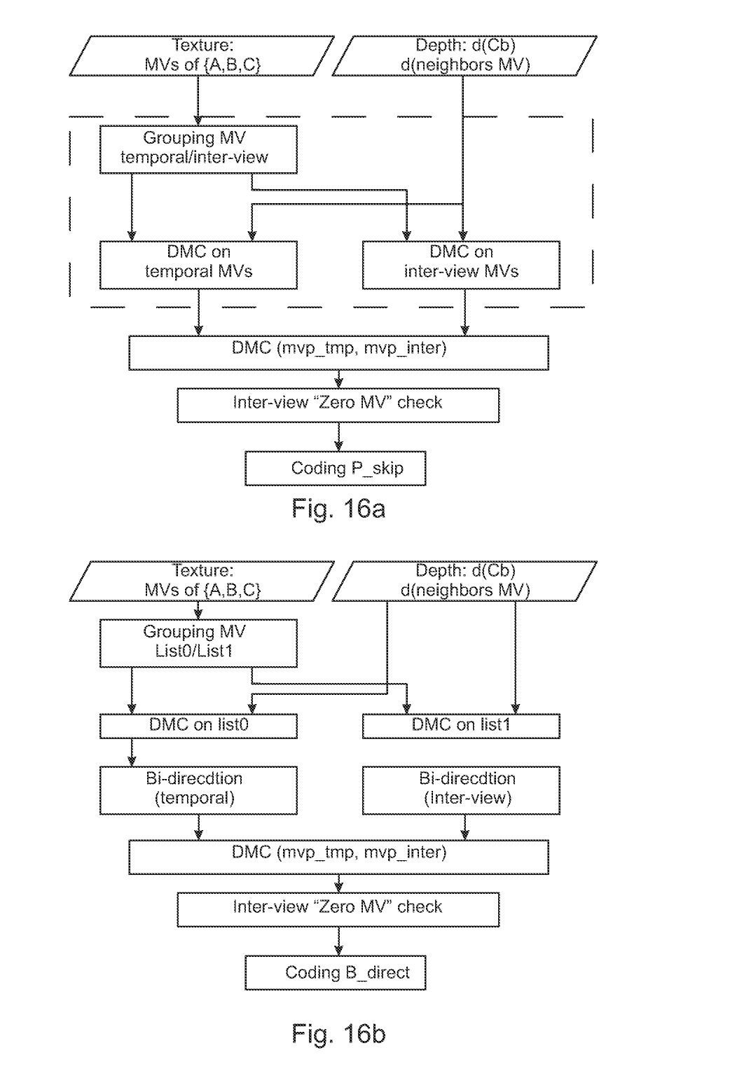

The depth-based MV competition for skip and direct modes may be described in the context of 3DV-ATM as follows. Flow charts of the process for the proposed Depth-based Motion Competition (DMC) in the Skip and Direct modes are shown in FIGS. 16a and 16b, respectively. In the Skip mode, motion vectors {mvᵢ} of texture data blocks {A, B, C} are grouped according to their prediction direction forming Group 1 and Group 2 for temporal and inter-view respectively. The DMC process, which is detailed in the grey block of FIG. 16a), may be performed for each group independently.

For each motion vector mvᵢ within a given Group, a motion-compensated depth block d(cb, mvᵢ) may be first derived, where the motion vector my, is applied relatively to the position of d(cb) to obtain the depth block from the reference depth map pointed to by mvᵢ. Then, the similarity between d(cb) and d(cb,mvᵢ) may be estimated by:

SAD(mvᵢ)=SAD(d(cb,mvᵢ),d(cb))

The mvᵢ that provides a minimal sum of absolute differences (SAD) value within a current Group may be selected as an optimal predictor for a particular direction (mvp_{dir})

$${mvp}_{dir} = arg {min}_{{mvp}_{dir}} ( SAD ( {mv}_{i} ) )$$

Following this, the predictor in the temporal direction (mvpₜₘₚ) is competed against the predictor in the inter-view direction (mvpᵢₙₜₑᵣ). The predictor which provides a minimal SAD can be gotten by:

$${mvp}_{opt} = {min}_{{mvp}_{dir}} ( SAD ( {mvp}_{tmp} ) , SAD ( {mvp}_{inter} ) )$$

Finally, mvpₒₚₜ which refers to another view (inter-view prediction) may undergo the following sanity check: In the case of “Zero-MV” is utilized it is replaced with a “disparity-MV” predictor mv_{y}=0 and mvₓ= D̅(cb), where D̅(cb) may be derived as described above.

The MVP for the Direct mode of B slices, illustrated in FIG. 16b), may be similar to the Skip mode, but DMC (marked with grey blocks) may be performed over both reference pictures lists (List 0 and List 1) independently. Thus, for each prediction direction (temporal or inter-view) DMC produces two predictors (mvp0_{dir} and mvp1_{dir}) for List 0 and List 1, respectively. Following, the bi-direction compensated block derived from mvp0_{dir} and mvp1_{dir} may be computed as follows:

$$d ( cb , {mvp}_{dir} ) = \frac{d ( cb , mvp {0}_{dir} ) + d ( cb , mvp {1}_{dir} )}{2}$$

Then, SAD value between this bi-direction compensated block and Cb may be calculated for each direction independently and the MVP for the Direct mode may be selected from available mvpᵢₙₜₑᵣ and mvpₜₘₚ as shown above for the skip mode. Similarly to the Skip mode, “zero-MV” in each reference list may be replaced with “disparity-MV”, if mvpₒₚₜ refers to another view (inter-view prediction).

Depth/disparity-based intra prediction for texture view for the purposes of multi-view coding (MVC), depth-enhanced video coding, multiview+depth (MVD) coding and multi-view with in-loop view synthesis (MVC-VSP) may be described as follows. Depth/disparity-based intra prediction of texture may be considered to include a set of new intra prediction mechanisms based on utilization of the depth or disparity information (Di) for a current block (cb) of texture data. It is assumed that the depth or disparity information (Di) for a current block (cb) of texture data is available through decoding of coded depth or disparity information or can be estimated at the decoder side prior to decoding of the current texture block, and this information can be utilized in intra prediction.

In the following, a texture block typically refers to a block of samples of a single color component of a texture picture, i.e. typically a block of samples of one of the luma or chroma components of a texture picture.

The encoder may include one or more of the following operations for coding of intra-coded texture blocks. It should be noted here that similar principles are also applicable at a decoder side for decoding of intra-coded texture blocks. While depth-based intra prediction for texture is described with reference to depth, it is to be understood that disparity or parallax could be used similarly in place of depth. The description refers to term block, which may be for example a macroblock similar to that used in H.264/AVC, a treeblock similar to that used in a HEVC WD, or anything alike.

Depth Boundary Detection

The encoder may apply depth boundary detection e.g. as follows. A depth boundary may also be referred to as a depth edge, a depth discontinuity, or a depth contour, for example. In the encoder, an associated (reconstructed/decoded) depth block is classified to either contain a depth boundary or not. The same depth boundary detection algorithm may also be performed in the decoder, and then both the encoder and decoder perform the depth boundary detection for reconstructed/decoded depth pictures. The detected depth boundaries may be used in one or more of the operations described below.

The encoder and the decoder may try to detect possible edges or other boundaries within a picture or a block e.g. by using an edge or boundary detection algorithm. There may be many possible algorithms which may be applied. For example, the depth boundary classification may be done as follows. The classification may use a Sobel operator using the following two 3×3 kernels to obtain a gradient magnitude image G:

$${G}_{x} = [ \begin{matrix}- 1 & 0 & + 1 \\ - 2 & 0 & + 2 \\ - 1 & 0 & + 1\end{matrix} ] * A$$

$$and$$

$${G}_{y} = [ \begin{matrix}- 1 & - 2 & - 1 \\ 0 & 0 & 0 \\ + 1 & + 2 & + 1\end{matrix} ] * A$$

$$G = \sqrt{{G}_{x}^{2} + {G}_{y}^{2}}$$

where A is the source image (the reconstructed depth image).

As sequences may have different dynamic sample value ranges in G value, G may be converted to image G′ using histogram equalization. In the histogram equalization, the min and max values of G′ may be set to 0 and 255, respectively. Further, a first threshold T1 and a second threshold T2 may also be set to appropriate values. The encoder or the decoder may examine if G′ (x, y)>T1. If so, the point (x, y) is classified to the boundary points. When the histogram equalization has been performed for the current block, the number of possible boundary points in the current block may be checked to determine, if the number of boundary points in one block is larger than the second threshold T2. If so, this block is classified to contain a depth boundary.

The encoder may determine the value of any of the above-mentioned thresholds T1 and T2 for example based on encoding blocks with different values of the threshold and selecting the value of the threshold that is optimal according to the Lagrangian rate-distortion optimization equation. The encoder may indicate the determined values of the thresholds T1 and/or T2 within the bitstream, for example by encoding them as one or more syntax elements for example in a sequence parameter set, a picture parameter set, a slice parameter set, a picture header, a slice header, within a macroblock syntax structure, or anything alike The decoder may determine the thresholds T1 and/or T2 based on the information encoded in the bistream, such as one or more codewords indicating the value of thresholds T1 and/or T2.

A texture block contains, covers, includes, has, or is with a depth boundary when the depth block co-located with the texture block contains a depth boundary. Depth may be coded at a different spatial resolution than texture. Therefore, scaling according to the proportion of the spatial resolutions may be taken into account in the determination when a texture block contains or covers a depth boundary.

Depth-Based Picture Partitioning

The encoder may partition a picture on the basis of depth information. The encoder may code the picture partitioning into the bitstream, or the decoder may partition a picture on the basis of depth information. The encoder and decoder may change the block coding or decoding order according to the picture partitioning so that blocks of one picture partition may precede in coding or decoding order blocks of another picture partition.

The block coding order and respectively the decoding order may be changed so that texture blocks not containing a depth boundary are coded or decoded first e.g. in a raster-scan order while texture blocks including a depth boundary are skipped and coded or decoded subsequently. Texture blocks containing a depth boundary may be marked in encoding and/or decoding as not available for prediction for the blocks not containing a depth boundary (as if they were in a different slice and constrained intra prediction turned on).

The block coding order and respectively the decoding order may be changed so that texture blocks including a depth boundary are coded or decoded first e.g. in raster scan order, while texture blocks not containing a depth boundary are coded or decoded subsequently to the texture blocks including a depth boundary e.g. in a raster-scan order. Texture blocks not containing a depth boundary may be marked in encoding and/or decoding as not available for prediction for the blocks containing a depth boundary (as if they were in a different slice and constrained intra prediction turned on).

In the depth-based picture partitioning, the encoder may use slice_group_map_type 6 of flexible macroblock ordering of H.264/AVC, which enables to provide a macroblock-wise mapping from macroblocks to slice groups. The creation of the slice group map may be performed based on the classified depth edge macroblocks, i.e. all the macroblocks classified as not containing a depth edge belong to one slice group, and the macroblocks with a depth edge belong to another slice group.

The encoder and decoder may infer the slice group mapping based on the depth boundary classification of reconstructed/decoded depth view components. For example, all the macroblocks classified as not containing a depth edge belong to one slice group, and the macroblocks with a depth edge belong to another slice group.

In another example, all macroblocks of the same depth range may be classified in encoding and/or decoding to form a slice group while the macroblocks containing a depth edge may be classified in encoding and/or decoding to form their own slice group.

The slice group containing macroblocks classified to include a depth boundary may be coded or decoded after the other slice group(s). Alternatively, the slice group containing macroblocks classified to include a depth boundary may be coded or decoded before the other slice group(s).

The macroblocks are coded or decoded in raster-scan order or any other pre-defined order otherwise but the macroblocks containing a depth edge may be skipped and coded or decoded after all other macroblocks of the same slice. Alternatively, the macroblocks containing a depth edge may be coded or decoded before all other macroblocks of the same slice.

Depth-Based Block Partitioning

The encoder may partition a texture block on the basis of depth information. The encoder may perform block partitioning so that one set of block partitions contains a depth boundary while another set of block partitions does not contain any depth boundary. The encoder may select the block partitions using a defined criterion or defined criteria; for example, the encoder may select the size of blocks not containing a depth boundary to be as large as possible. The decoder may also run the same block partitioning algorithm, or the encoder may signal the used block partitioning to the decoder e.g. using conventional H.264/AVC block partitioning syntax element(s).

Intra-coded luma texture macroblocks may be partitioned in 16×16, 8×8, or 4×4 blocks for intra prediction, but it is obvious that also other block sizes may be applied. Furthermore, the blocks need not be squared blocks but other formats are also applicable. As a generalization, the block size may be represented as M×N in which M, NεZ₊.

The block partitioning of the depth block may be used as the block partitioning for the respective or co-located texture block.

No block partitioning may be coded or indicated in the bitstream. Therefore, the encoder and decoder may perform the same depth-based block partitioning.

When information on the block partitioning is delivered from the encoder to the decoder, there may be many options for that. For example, the information on the block partitioning may be entropy coded to a bitstream. Entropy coding of the block partitioning may be performed in many ways. For example, the encoder signals the used block partitioning to the decoder e.g. using a H.264/AVC block partitioning syntax element(s). The block partitioning may be coded into the bitstream but the depth-based block partitioning is applied in both encoder and decoder to modify the context state of a context adaptive binary arithmetic coding (CABAC) or context-based variable length coding or any similar entropy coding in such a manner that the block partitioning chosen by the depth-based block partitioning method uses smaller amount of coded data bits. In effect, the likelihood of the block partitioning deduced by the depth-based block partitioning derivation is increased in the entropy coding and decoding.

The block partitioning may be coded into the bitstream but the code table or binarization table used in the block partitioning codeword may be dependent on the result of the depth-based block partitioning.

The used block partitioning method may be selected by the encoder e.g. through rate-distortion optimization and may be indicated by the encoder as a syntax element or elements or a value of a syntax element in the coded bitstream. The syntax element(s) may reside for example in the sequence parameter set, picture parameter set, adaptation parameter set, picture header, or slice header.

The encoder may, for example, perform conventional block partitioning selection e.g. using a rate-distortion optimization. If the rate-distortion cost of conventional block partitioning is smaller than that of the depth-based bock partitioning, the encoder may choose to use a conventional block partitioning and indicate the use of the conventional block partitioning in the bitstream for example in the slice header, macroblock syntax, or block syntax.

The decoder may decode the syntax element(s) related to the block partitioning method and decode the bitstream using the indicated block partitioning methods and related syntax elements.

The coding or decoding order of sub-blocks or block partitions within a block may be determined based on the depth boundary or boundaries. For example, in H.264/AVC based coding or decoding, the coding order of blocks according to the block partitioning within a macroblock may be determined based on the depth boundaries. The blocks without a depth boundary may be coded or decoded prior to the blocks having a depth boundary.

For example, for coding or decoding a texture macroblock containing a depth boundary in a H.264/AVC based coding/decoding scheme, the 8×8 blocks not containing a depth boundary (if any) may be coded or decoded first. Following that, the 4×4 blocks not containing a depth boundary (which reside in those 8×8 blocks that contain depth boundaries) may be coded or decoded. Finally, the 4×4 blocks containing a depth boundary may be coded or decoded using for example a bi-directional intra prediction mode.

In another example for an H.264/AVC based coding/decoding scheme, the 4×4 texture blocks containing a depth boundary are coded or decoded first. Then, the remaining samples of the texture macroblock are predicted from the boundary samples of the neighboring texture macroblocks and the reconstructed/decoded 4×4 texture blocks including a depth boundary.

Block partitioning is conventionally performed using a regular grid of sub-block positions. For example, in H.264/AVC, the macroblock may be partitioned to 4×4 or larger blocks at a regular 4×4 grid within the macroblock. Block partitioning of texture blocks may be applied in a manner that at least one of the coordinates of a sub-block position differs from a regular grid of sub-block positions. Sub-blocks having a depth boundary may for example be selected in a manner that their vertical coordinate follows the regular 4×4 grid but that their horizontal coordinate is chosen for example to minimize the number of 4×4 sub-blocks having a depth boundary.

The block partitioning used for intra prediction of a texture block may differ from the block partitioning used for prediction error coding or decoding of the same texture block. For example, any of the methods above based on the detection of a depth boundary may be used for determining the block partitioning for intra prediction of a texture block, and a different block partitioning may be used for transform-coded prediction error coding or decoding. The encoder and/or the decoder may infer the block partitioning used for intra prediction of the texture based on the co-located or respective depth reconstructed or decoded depth. The encoder may encode into the bitstream the block partitioning for prediction error coding of the intra-coded texture block, and the decoder may decode the block partitioning used for prediction error decoding of the intra-coded texture block from the bitstream. The encoder may, for example, use rate-distortion optimization when selecting whether or not the intra prediction and prediction error coding/decoding use the same block partitioning.

Depth-Based Intra Prediction Mode Determination

The encoder and/or the decoder may determine an intra-prediction mode by using the depth information. The depth of the current texture block being coded or decoded may be compared to the depth of the neighboring texture blocks or boundary samples of the depth blocks co-located or corresponding to the neighboring texture blocks, and the intra prediction mode of the current texture block may be determined on the basis of this comparison. For example, if the depth of the current texture block is very similar to the depth of the boundary samples, a DC prediction may be inferred. In another example, a depth boundary is detected in the current depth block and a bi-directional intra prediction for the current texture block is inferred.

As the intra prediction mode may be inferred in the encoder and the decoder, no syntax element may be coded and bitrate may be reduced. The use of depth-based intra prediction mode determination may be signaled for example in the slice header and the encoder may turn a depth-based intra prediction mode on using rate-distortion optimized decision comparing a depth-based prediction mode determination and a conventional intra prediction mode determination and syntax element coding.

The intra prediction mode of the depth block may be used for intra prediction of the respective or co-located texture block (in both the encoder and decoder).

The depth of the current texture block being coded or decoded may be compared to the depth of the neighboring texture blocks or boundary samples of the depth blocks co-located or corresponding to the neighboring texture blocks, and the intra prediction mode of the current texture block may be determined on the basis of this comparison. For example, if the depth of the current texture block is very similar to the depth of the boundary samples, a DC prediction may be inferred or a conventional intra prediction mode signaling may be inferred. In another example, a depth boundary is detected in the current depth block and a bi-directional intra prediction for the current texture block is inferred.

Similarly to the block partitioning, there are multiple options for entropy coding of the intra prediction mode, including the following. The bi-directional intra prediction mode may be inferred when there is a depth boundary within the block, and otherwise conventional intra prediction may be used for the block, where encoder determines the intra prediction mode and indicates it in the bitstream. As the intra prediction mode is inferred in both the encoder and decoder, no syntax element is coded.

In another option, the intra prediction mode may be coded into the bitstream but the depth-based prediction of the intra prediction mode may be applied in both encoder and decoder to modify the context state of CABAC or context-based variable length coding or any similar entropy coding in such a manner that the intra prediction mode chosen by the depth-based algorithm may use a smaller amount of coded data bits. In effect, the likelihood of the intra prediction mode deduced by the depth-based algorithm may be increased in the entropy coding and decoding.

In yet another option the intra prediction mode may be coded into the bitstream but the code table or binarization table used in the intra prediction mode codeword may be dependent on the result of the depth-based algorithm.

The use of depth-based intra prediction mode determination may be signaled for example in the slice header, macroblock syntax, or block syntax and the encoder may turn it on using rate-distortion optimized decision comparing depth-based prediction mode determination and conventional intra prediction mode determination.

The encoder may, for example, perform conventional intra prediction mode selection e.g. using rate-distortion optimization. If the rate-distortion cost of conventional intra prediction is smaller than that of the depth-based intra prediction mode selection, the encoder may choose to use conventional intra prediction and indicate the use of the conventional intra prediction in the bitstream, for example in the slice header, macroblock syntax, or block syntax.

The decoder may decode the syntax element(s) related to the intra prediction mode and decode the bitstream using the indicated intra prediction mode and related syntax elements.

Depth-Based Sample Availability for Intra Prediction

The encoder and/or the decoder may also determine whether there exist one or more samples for intra prediction. Only samples that are classified in encoding and/or decoding to belong to the same object using as a sample being predicted may be used as a prediction source. The classification to the same object may be done e.g. through comparing depth sample values e.g. by considering only those sample locations for which depth sample values are sufficiently close to each other to belong to the same object.

In an example implementation, the encoder and/or decoder decisions on the intra coding mode and macroblock partitioning as well as on the intra prediction mode decisions for texture blocks may be done independently of the respective depth pictures. However, the availability information of texture samples for intra prediction may be modified according to the available depth information.

Bi-Directional Intra Prediction for Blocks Containing a Depth Boundary

It is also possible that the encoder and the decoder use bi-directional intra prediction for texture blocks containing a depth boundary. Bi-directional intra prediction may be more efficient when the depth components are encoded and decoded before the texture components. Hence, the depth components of possibly all neighboring blocks of the current block may be available when encoding or decoding the texture components of the current block.

A texture block to be coded or decoded may be divided into two or more depth regions. The boundary samples of neighboring texture blocks may be classified in encoding and/or decoding also to the equivalent two or more depth regions. Samples within a particular depth region in the block being coded or decoded may then be predicted only from the respective boundary samples of the neighboring blocks. Different prediction direction or intra prediction mode may be selected for different regions.

One or more of the following steps may be performed for bi- or multi-directional intra prediction of texture blocks containing a depth boundary.

a. A new intra prediction mode for bi-directional intra prediction is specified in addition to the regular intra modes as specified below.

b. The encoder makes a rate-distortion optimized decision of the block partitioning, such as macroblock or treeblock partitioning, and the coding modes used by including the new bi-directional intra prediction as one of the tested modes. As a generalization, there could be more than two intra prediction directions, i.e. tri-directional intra prediction or generally n-directional intra prediction, where n is a positive integer.

c. If the texture block (of any size and shape such as 16×16, 8×8, and 4×4) contains a depth boundary, the availability of block boundary samples at neighboring blocks may be determined. The block or macroblock coding and decoding order may be changed, and the block to be predicted may be surrounded from up to four sides by available block boundary samples at neighboring blocks.

d. If the available block boundary samples at neighboring texture blocks co-locate with depth samples that are from different depth ranges, then bi-directional intra prediction mode may be available for the encoder and/or the decoder.

The availability of the bi-directional intra prediction mode may be used to tune entropy coding e.g. by setting the probability of the bi-directional intra mode to zero in CABAC or selecting a code table that excludes the bi-directional intra mode in context-adaptive variable-length coding if the bi-directional intra prediction mode is not available.

e. Two most prominent depth regions may be selected in encoding and/or decoding from the available block boundary depth samples at neighboring blocks and from the depth block that co-locates the texture block being coded. For example, the two depth regions having the most samples in the depth block may be selected provided that block boundary depth samples at neighboring blocks for them are also available.

f. Each sample in the depth block may be mapped to one of the two most prominent depth regions, e.g. according to closest absolute difference to the median or average depth value of the depth region. As a result each sample in the texture block being coded may be mapped either depth region, which may be denoted as a depth region 0 or a depth region 1.

Steps e and f may be performed for example as follows: Let Dmax and Dmin be the maximum value and minimum value, respectively, in the reconstructed depth block that co-locates the texture block. Let a threshold value DThres=(Dmax+Dmin)/2. Samples in depth region 0 are such that for which depth<=DThres. Samples in depth region 1 are such that for which depth>DThres.

Depth regions may be determined to be contiguous. For example, a Wedgelet partitioning may be used in both encoder and decoder. For a Wedgelet partition, the two regions are defined to be separated by a straight line. The separation line is determined by the start point S and the end point P, both located on different borders of the block. The separation line may be described by the equation of a straight line. The start and end point for the Wedgelet partitioning may be determined for example by minimizing a cost function as follows. Different possibilities for S and P are tested and the respective cost is derived. For example, all possible combinations of S and P may be tested. For each pair of S and P, a representative value for region 0 and 1 is first determined for example by averaging the depth sample values in region 0 and 1, respectively. Then a cost may be counted for example by deriving a sum of absolute differences of the depth samples relative to the representative value of region 0 or 1, depending on which region the depth sample has been divided according to S and P. The values of S and P minimizing the cost are selected for the Wedgelet partitioning.

In some cases, the depth regions may be determined to be contiguous but may not be required to be separated by a straight line.

g. Intra prediction for the texture block may be performed separately for depth region 0 and depth region 1. Different intra prediction direction may be selected for depth region 0 than for depth region 1. The prediction direction may be inferred by both the encoder and decoder. Alternatively, the prediction direction may be determined by the encoder and signaled in the bitstream. In the latter case, two prediction direction codewords are coded, one for depth region 0 and another for depth region 1.

The sample availability for intra prediction may be depth-based, e.g. as described above. Another similar alternative is to classify the samples in the neighboring blocks that may be used for intra prediction to region 0 or region 1 by comparing their depth value with the threshold DThres. Samples from neighboring blocks classified in region 0 may be used to predict the samples of the region 0 in the current block being coded or decoded, and samples from neighboring blocks classified in region 1 are not used to predict the samples of the region 0 in the current block being coded or decoded. Region 1 of the current block being coded or decoded may be handled similarly.

The block or macroblock coding or decoding order may be changed, and a block to be predicted may be surrounded from up to four sides by available block boundary samples at neighboring blocks, and hence the intra prediction modes and the block boundary samples at neighboring blocks that they use may also differ from those currently in H.264/AVC or HEVC or any similar coding or decoding method or system. For example, the H.264/AVC intra prediction modes may be changed as follows.

In DC mode the region 0/1 is set to be the mean value of samples at neighboring blocks that surround the current block from any direction and that are also in the region 0/1.

In horizontal/vertical mode, if boundary samples of blocks from both sides of the current block are available, the boundary samples are weighted according to the Euclidean spatial distance to the sample being predicted. For example, if a horizontal coordinate of prediction sample p1 is x1=7 and a horizontal coordinate of prediction sample p2 is x2=16 and a horizontal coordinate of the sample being predicted is x=10, and horizontal prediction is used, the prediction sample may be derived using m=(x2−x1)=9 as ((m−(x−x1))*p1+(m−(x2−x))*p2)/m=((9−(10⁻⁷))*p1+(9−(16−10))*p2)/9=(6*p1+3*p2)/9. If only one boundary sample is available, it is used as such as a prediction. If no boundary samples are available, the value obtained by through DC prediction may be used.

Depth-Weighted Intra Prediction

The encoder and the decoder may use the depth information for weighting purposes in intra prediction. The depth-based weight for intra prediction of texture may be a non-binary value, such as a fractional value, that is based on the difference between the depth of the texture sample being predicted and the depth of the prediction sample.

More than one prediction sample may be used for predicting a single sample. Furthermore, a binary weight may be used, i.e. if a prediction sample is classified to belong to a different depth region as the sample being predicted, a weight of 0 may be used. Otherwise, an equal weight for all prediction samples may be used. In some cases, an additional multiplicative weight may have been determined based on Euclidean spatial distance between the prediction sample and the sample being predicted.

In some cases, the depth-based weight may be a non-binary value, such as a fractional value. For example, the following derivation may be used. Let the depth value of the sample being predicted be denoted d. Let the prediction samples be denoted pi and the depth value of prediction samples be denoted di, where i is an index of the prediction samples. The depth of prediction samples may also include values that are derived from multiple depth samples, such as the average of all boundary samples of neighboring depth blocks that classified to belong to the same depth region as the depth of the sample being predicted. Let S be equal to Eabs(di−D) over all values of i=1 to n, inclusive, where n is the number of prediction samples. Let wi defined for each prediction be equal to (S−Σabs(dj−D))/S for values of j=1 to n, inclusive, where j≠i. The prediction sample p may then be derived as Σ(wi*pi) over all values of i=1 to n, inclusive.

It is to be understood that while many of the coding tools have been described in the context of a particular codec, such as 3DV-ATM, they could similarly be applied to other codec structures, such as a depth-enhanced multiview video coding extension of HEVC.

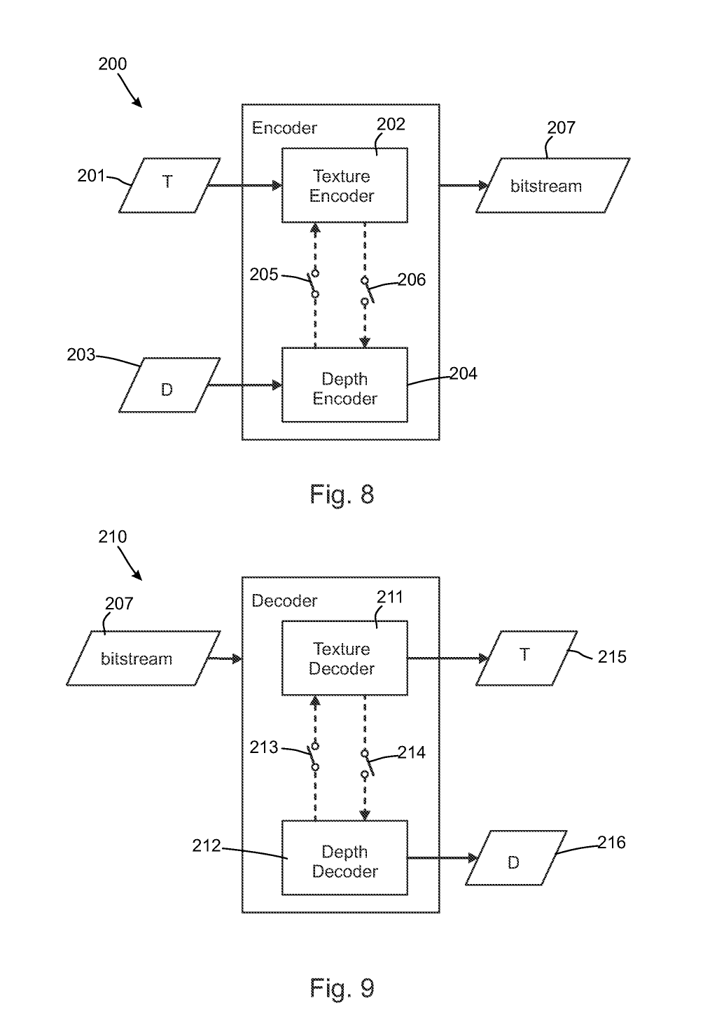

A high level flow chart of an embodiment of an encoder 200 capable of encoding texture views and depth views is presented in FIG. 8 and a decoder 210 capable of decoding texture views and depth views is presented in FIG. 9. On these figures solid lines depict general data flow and dashed lines show control information signaling. The encoder 200 may receive texture components 201 to be encoded by a texture encoder 202 and depth map components 203 to be encoded by a depth encoder 204. When the encoder 200 is encoding texture components according to AVC/MVC a first switch 205 may be switched off. When the encoder 200 is encoding enhanced texture components the first switch 205 may be switched on so that information generated by the depth encoder 204 may be provided to the texture encoder 202. The encoder of this example also comprises a second switch 206 which may be operated as follows. The second switch 206 is switched on when the encoder is encoding depth information of AVC/MVC views, and the second switch 206 is switched off when the encoder is encoding depth information of enhanced texture views. The encoder 200 may output a bitstream 207 containing encoded video information.

The decoder 210 may operate in a similar manner but at least partly in a reversed order. The decoder 210 may receive the bitstream 207 containing encoded video information. The decoder 210 comprises a texture decoder 211 for decoding texture information and a depth decoder 212 for decoding depth information. A third switch 213 may be provided to control information delivery from the depth decoder 212 to the texture decoder 211, and a fourth switch 214 may be provided to control information delivery from the texture decoder 211 to the depth decoder 212. When the decoder 210 is to decode AVC/MVC texture views the third switch 213 may be switched off and when the decoder 210 is to decode enhanced texture views the third switch 213 may be switched on. When the decoder 210 is to decode depth of AVC/MVC texture views the fourth switch 214 may be switched on and when the decoder 210 is to decode depth of enhanced texture views the fourth switch 214 may be switched off. The Decoder 210 may output reconstructed texture components 215 and reconstructed depth map components 216.

Many video encoders utilize the Lagrangian cost function to find rate-distortion optimal coding modes, for example the desired macroblock mode and associated motion vectors. This type of cost function uses a weighting factor or λ to tie together the exact or estimated image distortion due to lossy coding methods and the exact or estimated amount of information required to represent the pixel/sample values in an image area. The Lagrangian cost function may be represented by the equation:

C=D+λR

where C is the Lagrangian cost to be minimised, D is the image distortion (for example, the mean-squared error between the pixel/sample values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

A coding standard may include a sub-bitstream extraction process, and such is specified for example in SVC, MVC, and HEVC. The sub-bitstream extraction process relates to converting a bitstream by removing NAL units to a sub-bitstream. The sub-bitstream still remains conforming to the standard. For example, in a draft HEVC standard, the bitstream created by excluding all VCL NAL units having a temporal_id greater than or equal to a selected value and including all other VCL NAL units remains conforming. Consequently, a picture having temporal_id equal to TID does not use any picture having a temporal_id greater than TID as inter prediction reference.

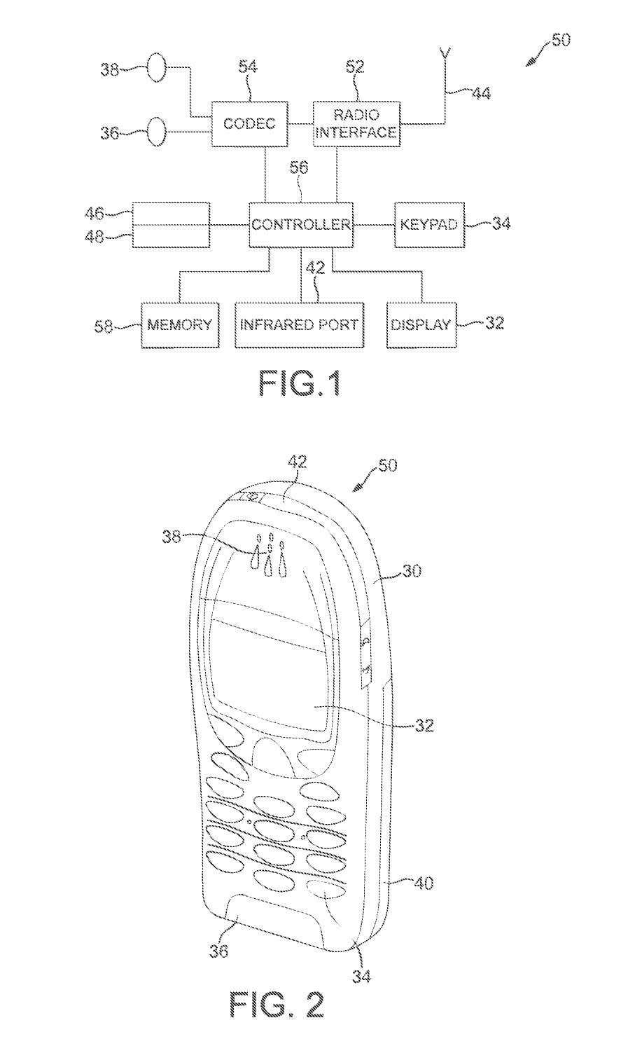

FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

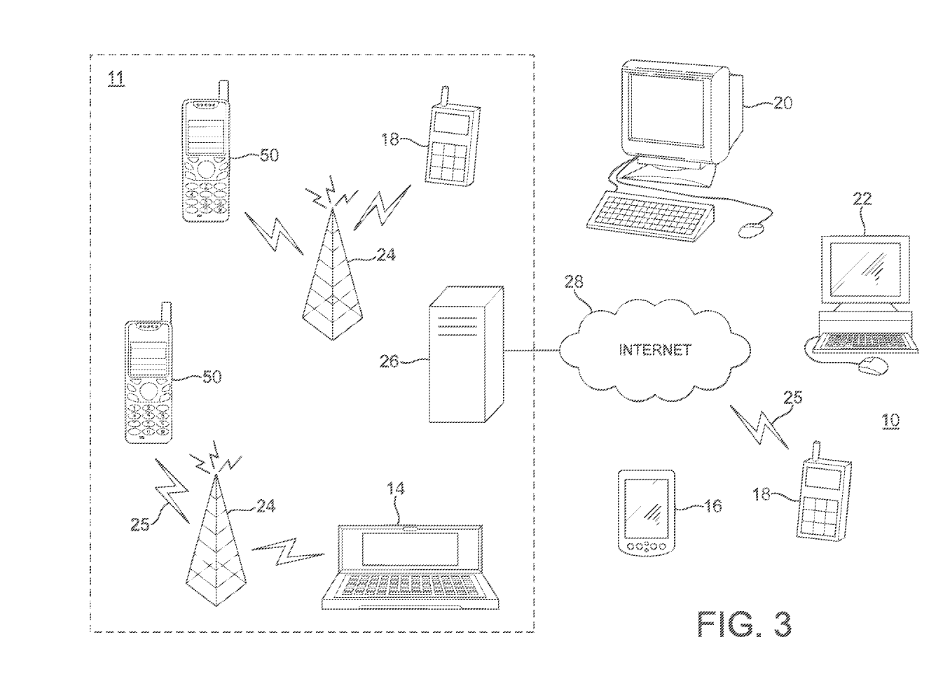

FIG. 3 shows an arrangement for video coding comprising a plurality of apparatuses, networks and network elements according to an example embodiment. With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

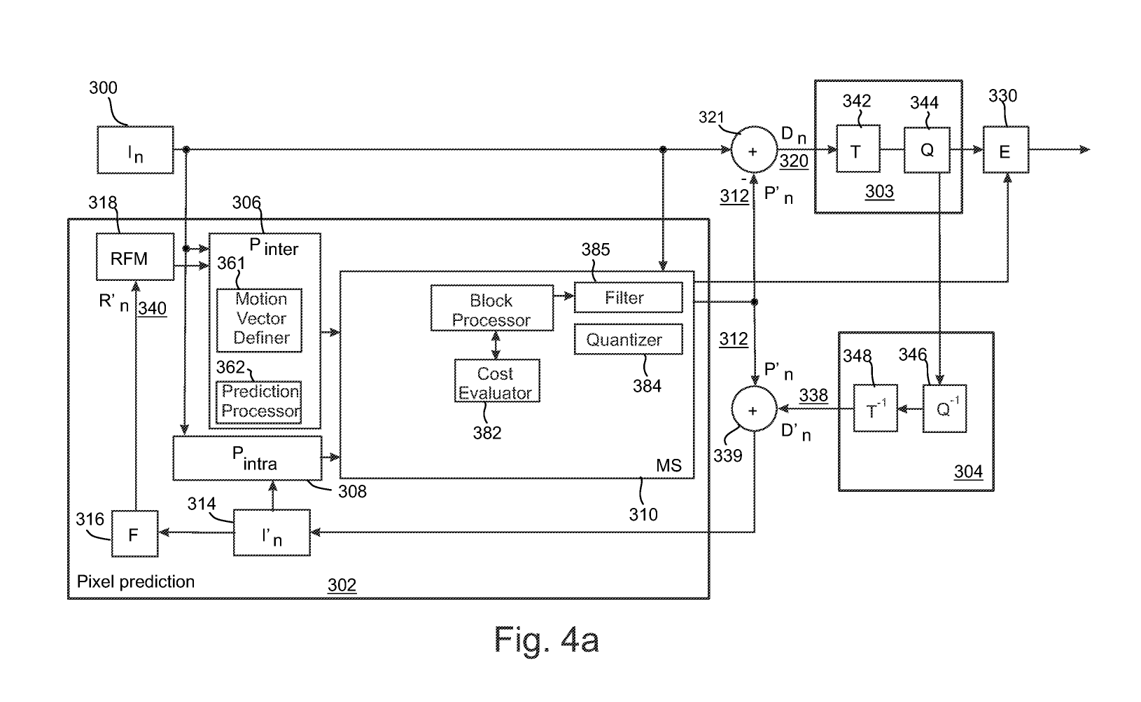

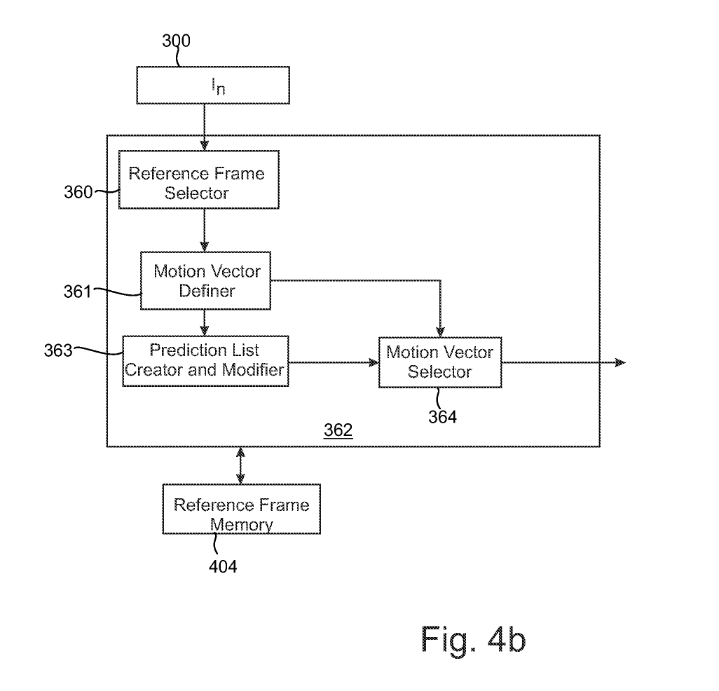

FIGS. 4a and 4b show block diagrams for video encoding and decoding according to an example embodiment.

FIG. 4a shows the encoder as comprising a pixel predictor 302, prediction error encoder 303 and prediction error decoder 304. FIG. 4a also shows an embodiment of the pixel predictor 302 as comprising an inter-predictor 306, an intra-predictor 308, a mode selector 310, a filter 316, and a reference frame memory 318. In this embodiment the mode selector 310 comprises a block processor 381 and a cost evaluator 382. The encoder may further comprise an entropy encoder 330 for entropy encoding the bit stream.

FIG. 4b depicts an embodiment of the inter predictor 306. The inter predictor 306 comprises a reference frame selector 360 for selecting reference frame or frames, a motion vector definer 361, a prediction list former 363 and a motion vector selector 364. These elements or some of them may be part of a prediction processor 362 or they may be implemented by using other means.

The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of a current frame or picture). The output of both the inter-predictor and the intra-predictor are passed to the mode selector 310. Both the inter-predictor 306 and the intra-predictor 308 may have more than one intra-prediction modes. Hence, the inter-prediction and the intra-prediction may be performed for each mode and the predicted signal may be provided to the mode selector 310. The mode selector 310 also receives a copy of the image 300.

The mode selector 310 determines which encoding mode to use to encode the current block. If the mode selector 310 decides to use an inter-prediction mode it will pass the output of the inter-predictor 306 to the output of the mode selector 310. If the mode selector 310 decides to use an intra-prediction mode it will pass the output of one of the intra-predictor modes to the output of the mode selector 310.

The mode selector 310 may use, in the cost evaluator block 382, for example Lagrangian cost functions to choose between coding modes and their parameter values, such as motion vectors, reference indexes, and intra prediction direction, typically on block basis. This kind of cost function may use a weighting factor lambda to tie together the (exact or estimated) image distortion due to lossy coding methods and the (exact or estimated) amount of information that is required to represent the pixel values in an image area: C=D+lambdaλR, where C is the Lagrangian cost to be minimized, D is the image distortion (e.g. Mean Squared Error) with the mode and their parameters, and R the number of bits needed to represent the required data to reconstruct the image block in the decoder (e.g. including the amount of data to represent the candidate motion vectors).

The output of the mode selector is passed to a first summing device 321. The first summing device may subtract the pixel predictor 302 output from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which the future image 300 is compared in inter-prediction operations. In many embodiments the reference frame memory 318 may be capable of storing more than one decoded picture, and one or more of them may be used by the inter-predictor 306 as reference pictures against which the future images 300 are compared in inter prediction operations. The reference frame memory 318 may in some cases be also referred to as the Decoded Picture Buffer.

The operation of the pixel predictor 302 may be configured to carry out any known pixel prediction algorithm known in the art.

The pixel predictor 302 may also comprise a filter 385 to filter the predicted values before outputting them from the pixel predictor 302.

The operation of the prediction error encoder 302 and prediction error decoder 304 will be described hereafter in further detail. In the following examples the encoder generates images in terms of 16×16 pixel macroblocks which go to form the full image or picture. However, it is noted that FIG. 4a is not limited to block size 16×16, but any block size and shape can be used generally, and likewise FIG. 4a is not limited to partitioning of a picture to macroblocks but any other picture partitioning to blocks, such as coding units, may be used. Thus, for the following examples the pixel predictor 302 outputs a series of predicted macroblocks of size 16×16 pixels and the first summing device 321 outputs a series of 16×16 pixel residual data macroblocks which may represent the difference between a first macroblock in the image 300 against a predicted macroblock (output of pixel predictor 302).

The prediction error encoder 303 comprises a transform block 342 and a quantizer 344. The transform block 342 transforms the first prediction error signal 320 to a transform domain. The transform is, for example, the DCT transform or its variant. The quantizer 344 quantizes the transform domain signal, e.g. the DCT coefficients, to form quantized coefficients.

The prediction error decoder 304 receives the output from the prediction error encoder 303 and produces a decoded prediction error signal 338 which when combined with the prediction representation of the image block 312 at the second summing device 339 produces the preliminary reconstructed image 314. The prediction error decoder may be considered to comprise a dequantizer 346, which dequantizes the quantized coefficient values, e.g. DCT coefficients, to reconstruct the transform signal approximately and an inverse transformation block 348, which performs the inverse transformation to the reconstructed transform signal wherein the output of the inverse transformation block 348 contains reconstructed block(s). The prediction error decoder may also comprise a macroblock filter (not shown) which may filter the reconstructed macroblock according to further decoded information and filter parameters.

In the following the operation of an example embodiment of the inter predictor 306 will be described in more detail. The inter predictor 306 receives the current block for inter prediction. It is assumed that for the current block there already exists one or more neighboring blocks which have been encoded and motion vectors have been defined for them. For example, the block on the left side and/or the block above the current block may be such blocks. Spatial motion vector predictions for the current block can be formed e.g. by using the motion vectors of the encoded neighboring blocks and/or of non-neighbor blocks in the same slice or frame, using linear or non-linear functions of spatial motion vector predictions, using a combination of various spatial motion vector predictors with linear or non-linear operations, or by any other appropriate means that do not make use of temporal reference information. It may also be possible to obtain motion vector predictors by combining both spatial and temporal prediction information of one or more encoded blocks. These kinds of motion vector predictors may also be called as spatio-temporal motion vector predictors.

Reference frames used in encoding may be stored to the reference frame memory. Each reference frame may be included in one or more of the reference picture lists, within a reference picture list, each entry has a reference index which identifies the reference frame. When a reference frame is no longer used as a reference frame it may be removed from the reference frame memory or marked as “unused for reference” or a non-reference frame wherein the storage location of that reference frame may be occupied for a new reference frame.

As described above, an access unit may contain slices of different component types (e.g. primary texture component, redundant texture component, auxiliary component, depth/disparity component), of different views, and of different scalable layers. A component picture may be defined as a collective term for a dependency representation, a layer representation, a texture view component, a depth view component, a depth map, or anything like. Coded component pictures may be separated from each other using a component picture delimiter NAL unit, which may also carry common syntax element values to be used for decoding of the coded slices of the component picture. An access unit can consist of a relatively large number of component pictures, such as coded texture and depth view components as well as dependency and layer representations. The coded size of some component pictures may be relatively small for example because they can be considered to represent deltas relative to base view or base layer and because depth component pictures may be relatively easy to compress. When component picture delimiter NAL units are present in the bitstream, a component picture may be defined as a component picture delimiter NAL unit and the subsequent coded slice NAL units until the end of the access unit or until the next component picture delimiter NAL unit, exclusive, whichever is earlier in decoding order.

Inter-component prediction may be defined to comprise prediction of syntax element values, sample values, variable values used in the decoding process, or anything alike from a component picture of one type to a component picture of another type. For example, inter-component prediction may comprise prediction of a texture view component from a depth view component, or vice versa.

It has been proposed that at least a subset of syntax elements that have conventionally been included in a slice header are included in a GOS (Group of Slices) parameter set by an encoder. An encoder may code a GOS parameter set as a NAL unit. GOS parameter set NAL units may be included in the bitstream together with for example coded slice NAL units, but may also be carried out-of-band as described earlier in the context of other parameter sets.

The GOS parameter set syntax structure may include an identifier, which may be used when referring to a particular GOS parameter set instance for example from a slice header or another GOS parameter set. Alternatively, the GOS parameter set syntax structure does not include an identifier but an identifier may be inferred by both the encoder and decoder for example using the bitstream order of GOS parameter set syntax structures and a pre-defined numbering scheme.

The encoder and the decoder may infer the contents or the instance of GOS parameter set from other syntax structures already encoded or decoded or present in the bitstream. For example, the slice header of the texture view component of the base view may implicitly form a GOS parameter set. The encoder and decoder may infer an identifier value for such inferred GOS parameter sets. For example, the GOS parameter set formed from the slice header of the texture view component of the base view may be inferred to have identifier value equal to 0.

A GOS parameter set may be valid within a particular access unit associated with it. For example, if a GOS parameter set syntax structure is included in the NAL unit sequence for a particular access unit, where the sequence is in decoding or bitstream order, the GOS parameter set may be valid from its appearance location until the end of the access unit. Alternatively, a GOS parameter set may be valid for many access units.

The encoder may encode many GOS parameter sets for an access unit. The encoder may determine to encode a GOS parameter set if it is known, expected, or estimated that at least a subset of syntax element values in a slice header to be coded would be the same in a subsequent slice header.

A limited numbering space may be used for the GOS parameter set identifier. For example, a fixed-length code may be used and may be interpreted as an unsigned integer value of a certain range. The encoder may use a GOS parameter set identifier value for a first GOS parameter set and subsequently for a second GOS parameter set, if the first GOS parameter set is subsequently not referred to for example by any slice header or GOS parameter set. The encoder may repeat a GOS parameter set syntax structure within the bitstream for example to achieve a better robustness against transmission errors.

Syntax elements which may be included in a GOS parameter set may be conceptually collected in sets of syntax elements. A set of syntax elements for a GOS parameter set may be formed for example on one or more of the following basis:
Syntax elements indicating a scalable layer and/or other scalability features
Syntax elements indicating a view and/or other multiview features
Syntax elements related to a particular component type, such as depth/disparity
Syntax elements related to access unit identification, decoding order and/or output order and/or other syntax elements which may stay unchanged for all slices of an access unit
Syntax elements which may stay unchanged in all slices of a view component
Syntax elements related to reference picture list modification
Syntax elements related to the reference picture set used
Syntax elements related to decoding reference picture marking
Syntax elements related to prediction weight tables for weighted prediction
Syntax elements for controlling deblocking filtering
Syntax elements for controlling adaptive loop filtering
Syntax elements for controlling sample adaptive offset
Any combination of sets above

For each syntax element set, the encoder may have one or more of the following options when coding a GOS parameter set:
The syntax element set may be coded into a GOS parameter set syntax structure, i.e. coded syntax element values of the syntax element set may be included in the GOS parameter set syntax structure.
The syntax element set may be included by reference into a GOS parameter set. The reference may be given as an identifier to another GOS parameter set. The encoder may use a different reference GOS parameter set for different syntax element sets.
The syntax element set may be indicated or inferred to be absent from the GOS parameter set.

The options from which the encoder is able to choose for a particular syntax element set when coding a GOS parameter set may depend on the type of the syntax element set. For example, a syntax element set related to scalable layers may always be present in a GOS parameter set, while the set of syntax elements which may stay unchanged in all slices of a view component may not be available for inclusion by reference but may be optionally present in the GOS parameter set and the syntax elements related to reference picture list modification may be included by reference in, included as such in, or be absent from a GOS parameter set syntax structure. The encoder may encode indications in the bitstream, for example in a GOS parameter set syntax structure, which option was used in encoding. The code table and/or entropy coding may depend on the type of the syntax element set. The decoder may use, based on the type of the syntax element set being decoded, the code table and/or entropy decoding that is matched with the code table and/or entropy encoding used by the encoder.

The encoder may have multiple means to indicate the association between a syntax element set and the GOS parameter set used as the source for the values of the syntax element set. For example, the encoder may encode a loop of syntax elements where each loop entry is encoded as syntax elements indicating a GOS parameter set identifier value used as a reference and identifying the syntax element sets copied from the reference GOP parameter set. In another example, the encoder may encode a number of syntax elements, each indicating a GOS parameter set. The last GOS parameter set in the loop containing a particular syntax element set is the reference for that syntax element set in the GOS parameter set the encoder is currently encoding into the bitstream. The decoder parses the encoded GOS parameter sets from the bitstream accordingly so as to reproduce the same GOS parameter sets as the encoder.

It has been proposed to have a partial updating mechanism for the Adaptation Parameter Set in order to reduce the size of APS NAL units and hence to spend a smaller bitrate for conveying APS NAL units. Although the APS provides an effective approach to share picture-adaptive information common at the slice level, coding of APS NAL units independently may be suboptimal when only a part of the APS parameters changes compared to one or more earlier Adaptation Parameter Sets.

A Group Parameter Set (GPS) was proposed in document JCTVC-H0505 (http://phenix.int-evry.fr/jct/doc_end_user/documents/8_San %20Jose/wg11/JCTVC-H0505-v2.zip). A GPS collects parameter set identifiers (IDs) and includes an identifier itself (self-reference). In particular a GPS includes a PPS ID and zero or more APS IDs. At most one GPS may be active at any moment during the decoding process. A GPS is activated if it is not already the active GPS and it is referred by a coded slice NAL unit being decoded. A coded slice NAL unit may include a GPS ID, instead of a PPS ID and an APS ID or IDs.

A video parameter set (VPS) was proposed in document JCTVC-H0388 (http://phenix.int-evry.fr/jct/doc_end_user/documents/8_San %20Jose/wg11/JCTVC-H0388-v4.zip). The relationship and hierarchy between VPS, SPS, and PPS may be described as follows. VPS resides one level above SPS in the parameter set hierarchy and in the context of scalability and/or 3DV. VPS includes parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations. VPS may provide information about the dependency relationships of the layers in a bitstream, as well as many other information that are applicable to all slices across all (scalability or view) layers in the entire coded video sequence. In a scalable extension of HEVC, VPS may for example include a mapping of the LayerId value derived from the NAL unit header to one or more scalability dimension values, for example correspond to dependency_id, quality_id, view_id, and depth_flag for the layer defined similarly to SVC and MVC. VPS may include profile and level information for one or more layers as well as the profile and/or level for one or more temporal sub-layers (consisting of VCL NAL units at and below certain temporal_id values) of a layer representation. A VPS may be activated as follows. At most one VPS may be active at a time. A VPS is activated when it is not already active and it is referred by a coded slice NAL unit in a particular layer in an IDR access unit being decoded. Once activated, the VPS applies to the entire coded video sequence. In other words, the active VPS can only change at an IDR access unit.

In some 3D video coding formats and methods there may be an underlying constraint that texture views use a different seq_parameter_set_{—}3dvc_extension or similar parameter set compared to depth views. Furthermore, texture views that are compatible with single-view or multiview profiles (without depth enhancement) may use a different sequence parameter set compared to texture views utilizing depth enhancements. In some coding formats and methods, sequence parameter set identifier may be provided in the picture parameter set as reference, and hence the number of required picture parameter sets may be at least as high as the number of sequence parameter sets. A major part of the sequence parameter sets and picture parameter sets may share the same values for the respective syntax elements. It may be therefore beneficial to reduce the number of used parameter sets in 3D video coding in order to simplify the encoding, decoding, and/or transmission as well as improve the compression performance.

In some 3D video coding formats and methods, seq_parameter_set_{—}3dvc_extension or similar parameter set may control turning on/off certain coding tools. For example in 3DV-ATM, seq_parameter_set_{—}3dvc_extension may control turning on/off JVDF, slice header prediction, IVMP, and VSP. However, the availability or use of many of these tools may depend on the texture and depth view component order within the access unit. For example, slice header prediction and IVMP may only available for depth view components that follow the respective texture view component in view component order. VSP may only available if the depth view component(s) for the texture view component(s) that are used as source for view synthesis precede, in view component order, that texture view component where the VSP reference is used.

Different view components may use different coding tools/methods/algorithms. For example, in 3DV-ATM bitstreams, the depth view component of the base view may follow the respective texture view component in view component order and may use slice header prediction and IVMP. However, the depth view component(s) of the non-base view(s) may precede the respective depth view component(s) and hence slice header prediction and IVMP may not be available.

In example embodiments, common notation for arithmetic operators, logical operators, relational operators, bit-wise operators, assignment operators, and range notation e.g. as specified in H.264/AVC or a draft HEVC may be used. Furthermore, common mathematical functions e.g. as specified in H.264/AVC or a draft HEVC may be used and a common order of precedence and execution order (from left to right or from right to left) of operators e.g. as specified in H.264/AVC or a draft HEVC may be used.

In example embodiments, the following descriptors may be used to specify the parsing process of each syntax element.
b(8): byte having any pattern of bit string (8 bits).
se(v): signed integer Exp-Golomb-coded syntax element with the left bit first.
u(n): unsigned integer using n bits. When n is “v” in the syntax table, the number of bits varies in a manner dependent on the value of other syntax elements. The parsing process for this descriptor is specified by n next bits from the bitstream interpreted as a binary representation of an unsigned integer with the most significant bit written first.
ue(v): unsigned integer Exp-Golomb-coded syntax element with the left bit first.

An Exp-Golomb bit string may be converted to a code number (codeNum) for example using the following table:

| Bit string | codeNum |
|---|---|
| 1 | 0 |
| 0 1 0 | 1 |
| 0 1 1 | 2 |
| 0 0 1 0 0 | 3 |
| 0 0 1 0 1 | 4 |
| 0 0 1 1 0 | 5 |
| 0 0 1 1 1 | 6 |
| 0 0 0 1 0 0 0 | 7 |
| 0 0 0 1 0 0 1 | 8 |
| 0 0 0 1 0 1 0 | 9 |
| . . . | . . . |

A code number corresponding to an Exp-Golomb bit string may be converted to se(v) for example using the following table:

| codeNum | syntax element value |
|---|---|
| 0 | 0 |
| 1 | 1 |
| 2 | −1 |
| 3 | 2 |
| 4 | −2 |
| 5 | 3 |
| 6 | −3 |
| . . . | . . . |

In example embodiments, syntax structures, semantics of syntax elements, and decoding process may be specified as follows. Syntax elements in the bitstream are represented in bold type. Each syntax element is described by its name (all lower case letters with underscore characters), optionally its one or two syntax categories, and one or two descriptors for its method of coded representation. The decoding process behaves according to the value of the syntax element and to the values of previously decoded syntax elements. When a value of a syntax element is used in the syntax tables or the text, it appears in regular (i.e., not bold) type. In some cases the syntax tables may use the values of other variables derived from syntax elements values. Such variables appear in the syntax tables, or text, named by a mixture of lower case and upper case letter and without any underscore characters. Variables starting with an upper case letter are derived for the decoding of the current syntax structure and all depending syntax structures. Variables starting with an upper case letter may be used in the decoding process for later syntax structures without mentioning the originating syntax structure of the variable. Variables starting with a lower case letter are only used within the context in which they are derived. In some cases, “mnemonic” names for syntax element values or variable values are used interchangeably with their numerical values. Sometimes “mnemonic” names are used without any associated numerical values. The association of values and names is specified in the text. The names are constructed from one or more groups of letters separated by an underscore character. Each group starts with an upper case letter and may contain more upper case letters.

In example embodiments, a syntax structure may be specified using the following. A group of statements enclosed in curly brackets is a compound statement and is treated functionally as a single statement. A “while” structure specifies a test of whether a condition is true, and if true, specifies evaluation of a statement (or compound statement) repeatedly until the condition is no longer true. A “do . . . while” structure specifies evaluation of a statement once, followed by a test of whether a condition is true, and if true, specifies repeated evaluation of the statement until the condition is no longer true. An “if . . . else” structure specifies a test of whether a condition is true, and if the condition is true, specifies evaluation of a primary statement, otherwise, specifies evaluation of an alternative statement. The “else” part of the structure and the associated alternative statement is omitted if no alternative statement evaluation is needed. A “for” structure specifies evaluation of an initial statement, followed by a test of a condition, and if the condition is true, specifies repeated evaluation of a primary statement followed by a subsequent statement until the condition is no longer true.

In various embodiments, the encoder may perform one or more of the following steps among others:
1. Determining inter-view prediction hierarchy of texture views and depth views and encoding indication(s) of the inter-view prediction hierarchies in a bitstream.
2. Determining view component order within an access unit, also referred to as AU view component order.
3. Encoding one or more indications of the AU view component order into a bitstream.
4. Inferring the use of one or more coding tools, modes of coding tools, and/or coding parameters based on the AU view component order.

In various embodiments, the decoder may perform one or more of the following steps among others:
1. Receiving and decoding indications of inter-view prediction hierarchies of texture and depth views from the bitstream.
2. Receiving and decoding one or more indications of the AU view component order from the bitstream.
3. Inferring, to be used in the decoding process, the use of one or more coding tools, modes of coding tools, and/or coding parameters based on the AU view component order.

Determining inter-view prediction hierarchy of texture views and depth views may be done in the encoder may be done for example as follows.

In some embodiments, the encoder may be configured to choose certain identical inter-view dependency order for texture views and depth views. Alternatively or in addition, the encoder may perform an optimization process which identical inter-view dependency order performs better than some others for example using rate-distortion metrics.

In some embodiments, the encoder selects the inter-view dependency order for texture views differently from depth views. For example, the encoder may be configured to choose certain inter-view dependency order for texture views and depth views. Alternatively or in addition, the encoder may perform an optimization process which inter-view dependency order performs better than some others for texture views and depth views for example using rate-distortion metrics.

Encoding indication(s) of the inter-view prediction hierarchies in a bitstream may be performed for example by coding indications in the video parameter set and/or sequence parameter set, for example using syntax of or similar to the sequence parameter set MVC extension. The encoder may indicate which video parameter set or sequence parameter set is in use by coding a parameter set identifier into a coded video NAL unit, such that it activates the parameter set including the inter-view prediction hierarchy description.

In some embodiments, determining view component order within an access unit, also referred to as AU view component order, may be performed as follows.

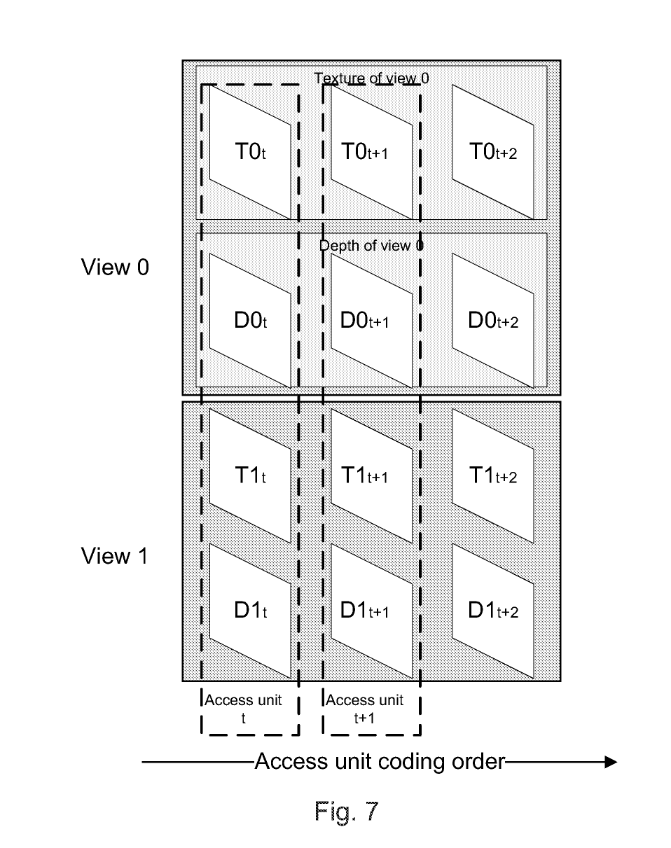

The coding and decoding order of texture and depth view components within an access unit may be such that the data of a coded view component is not interleaved by any other coded view component, and the data for an access unit is not interleaved by any other access unit in the bitstream/decoding order. For example, there may be two texture and depth views (T0ₜ, T1ₜ, T0ₜ₊₁, T1ₜ₊₁, T0ₜ₊₂, T1ₜ₊₂, D0ₜ, D1ₜ, D0ₜ₊₁, D1ₜ₊₁, D0ₜ₊₂, D1ₜ₊₂) in different access units (t, t+1, t+2), as illustrated in FIG. 7, where the access unit t consisting of texture and depth view components (T0ₜ,T1ₜ,D0ₜ,D1ₜ) precedes in bitstream and decoding order the access unit t+1 consisting of texture and depth view components (T0ₜ₊₁,T1ₜ₊₁, D0ₜ₊₁,D1ₜ₊₁).

The coding and decoding order of view components within an access unit may be governed by the coding format or determined by the encoder. The determined inter-view prediction hierarchy may restrict the coding and decoding order. The texture view components of the same access units may be coded in view dependency order, indicated by the view order index. Likewise, the depth view components of the same access units may be coded in view dependency order.

A texture view component may be coded before the respective depth view component of the same view, and hence such depth view components may be predicted from the texture view components of the same view. Such texture view components may be coded for example by MVC encoder and decoded by MVC decoder. An enhanced texture view component refers herein to a texture view component that is coded after the respective depth view component of the same view and may be predicted from the respective depth view component. For example, depth-based motion vector prediction (D-MVP) may be used in enhanced texture view component. In some embodiments, a depth view component may be coded before the respective texture view component of the same view, and hence such texture view components may be predicted from the depth view components of the same view. An encoder may therefore select the coding, bitstream, and decoding order of a depth view component and a texture view component of the same view based on the inter-component prediction tools it determines to use. Such determination may be based for example on one or more of the following:
If the encoded bitstream is desired to be compatible with a decoder capable of decoding single- or multi-view texture video, the encoder may decide not to use depth-based texture coding tools for a selected number of texture views and consequently code texture views prior to the respective depth views.
The encoder may perform an optimization process which inter-component coding tools and AU view component order performs better than some others for example in rate-distortion metrics.
The encoder may be configured to use or may determine to use certain coding tools, coding modes, and/or coding parameters, which impose constraints on the AU view component order. For example, if VSP is used as described earlier, both the texture view component and a depth view component of a view that is used as a reference for view synthesis prediction should precede in AU view component order the texture view component that is coded/decoded and for which the synthesized reference component is derived.

In some embodiments, the inter-view dependency orders of texture and depth views as well as the use of inter-component coding tools may together have an impact on determining the AU view component order. For example, if three views are coded and the encoder determined to use the PIP inter-view prediction hierarchy for texture views T0, T1, and T2, respectively (the midmost view is the base view, while the two other views are non-base views), and the IBP inter-view prediction hierarchy for depth views D0, D1, and D2, respectively (the left view is the base view, the right view may be predicted from the left view, and the middle view may be predicted from the left view and/or the right view), and the encoder decides to use the D-MVP coding tool or any other depth-based texture coding tool for non-base view texture coding, and inter-component prediction tools are not used for the base view of texture, the following constraints on AU view component order may be inferred in the encoder. As T1 is independently coded of D0, D1, and D2, it can have any order with respect to them. T0 requires D0 to be decoded before it, and similarly T2 requires D2 to be decoded before it, as the decoded sample values of D0 and D2 are used in the D-MVP tool for decoding T0 and T2, respectively. D1 is not used as inter-component prediction reference for T1 (or any other texture view), so its location in AU view component order is only governed by the inter-view dependency order of depth. Consequently, for example the following AU view component orders are possible: (T1, D0, D2, D1, T0, T2); (T1, D0, T0, D2, T2, D1); (T1, D0, D2, D1, T0, T2); (D0, D2, D1, T1, T0, T2).

In some embodiments, the sequence parameter set MVC extension need not have identical content for texture view components compared to its content for depth view components, thus an inter-view dependency order for texture views is allowed to be different from that for depth views.

In some embodiments, depth views may use a different active sequence parameter set from the active sequence parameter set of the texture view. Furthermore, one depth view may use (i.e. may have activated) a different sequence parameter from that of another depth view. Likewise, one texture view may use (i.e. may have activated) a different sequence parameter from that of another texture view.

In some embodiments, the encoder may be capable of parallel processing for example through multiple processors and/or processing cores, a graphics processing unit (GPU), or anything alike The encoder may assign texture and depth view components for encoding on different parallel processing units for example in an order determined by the inter-view prediction hierarchy and an inter-component dependency hierarchy, which may be determined for example according to the inter-component prediction tools to be used. When assigning view components for encoding in parallel processing units, the encoder should ensure that no processing is halted due to waiting of completion of encoding in another parallel processing unit. The completion order of encoding of view components might not be the same as the order the view components were assigned to be encoded in different parallel processing units. For example, in some coding arrangements depth view components may have a lower spatial resolution compared to that of texture view components, hence the encoding of depth view components is also likely to take a smaller processing time compared to that for the texture view components. The parallel processing units may be configured to output the encoded slices or view components into the bitstream at the order that they are completed. Consequently, in some embodiments, the AU view component order may be determined by the completion order of encoding of view components in one or more parallel processing units.

In many embodiments, the coding format allows to have the texture and depth view components of an access unit in any order with respect to each other as long as the ordering obeys both inter-view and inter-component prediction hierarchy. In other words, many coding formats have such constraints that enable decoding of the received bitstream in a linear order, e.g. in the order NAL units are received in the bitstream. That is, a received view component may be allowed to have dependencies on data appearing earlier in the bitstream and may be disallowed to have dependencies on data appearing later in the bitstream. The encoder may ensure that such constraints are obeyed in the bitstream by encoding view components in respective order and/or buffering the encoded data, re-ordering the buffered data such that the constraints are obeyed, and writing the re-ordered data into the bitstream.

In some embodiments, encoding one or more indications of the AU view component order into a bitstream may be performed in one of the following ways or with any similar method.

The syntax structure of the video parameter set or the sequence parameter set or similar may be appended or a new NAL unit type to carry scalability, view, and inter-component relationships may be specified to include syntax elements describing the AU view component order. For example, the following syntax may be used in example embodiments:

| | |
|---|---|
| video_parameter_set_rbsp( ) { | Descriptor |

| | |
|---|---|
| ... | |
| num_view_components | ue(v) |
| for( i = 0; i < num_view_components; i++ ) { | |

| | |
|---|---|
| au_vc_order_depth_flag[ i ] | u(1) |
| au_vc_order_voidx[ i ] | ue(v) |

}
...

The semantics of the syntax elements presented above may be specified as follows. num_view_components specifies the maximum number of texture and depth view components that may be present in an access unit. au_vc_order_depth_flag[i] equal to 0 or 1 specifies that the i-th view component in decoding order within an access unit is a texture view component or a depth view component, respectively. au_vc_order_voidx[i] specifies the view order index of the texture or depth view component in decoding order within an access unit. There may be fewer than num_view_components view components actually present in an access unit, in which case the order of those view components is the same as N first loop items in the syntax, where N is the number of view components actually present in the access unit. Alternatively to view order index, any other identifier of the view, such as view_id, may be used in the syntax.

If the AU view component order is present in a sequence parameter set or any other syntax structure of which multiple instances may be active for the same coded video sequence, the indicated AU view component order may be required to be identical in all such active syntax structures.

In some embodiments, a sequence parameter set syntax structure or any similar syntax structure may include a part for indicating AU view component order, which is conditional and applied only if the syntax structure is referred to be a depth view component. For example, a sequence parameter set 3DV extension syntax structure may be specified. The AU view component order may be specified in the syntax structure in a manner that indicates how depth view components are located or interleaved in relation to the texture view components, which appear in the access unit in an order determined by their view order index. For example, the following syntax or anything alike may be used:

| | |
|---|---|
| ... | |
| num_depth_view_components | ue(v) |
| for( i = 0; i < num_depth_view_components; i++ ) { | |

| | |
|---|---|
| au_vc_order_texture_voidx[ i ] | ue(v) |

}
...

The semantics of the syntax elements presented above may be specified as follows. num_view_depth_components specifies the maximum number of depth view components that may be present in an access unit. au_vc_order_texture_voidx[i] specifies the view order index of the texture view component that follows the depth view component having view order index equal to i in AU view component order. The view order index of texture view components also specifies their respective decoding order within an access unit. If the value of au_vc_order_texture_voidx[i] is one greater than the maximum value of view order index for texture view components, the depth view component with view order index equal to i follows the last texture view component in AU view component order. If au_vc_order_texture_voidx[i] is the same for more than one value of i, the respective depth view components are in ascending order of view order index i in the AU view component order.

In some embodiments, the AU view component order may be indicated in an access unit level for example in a picture parameter set, an adaptation parameter set, or an access unit delimiter. In some embodiments, AU view component order may be indicated in a level below the access unit, such a GOS parameter set, a picture header, a component picture delimiter, a component picture header, or a slice header, and the AU view component order may be required to be identical in all syntax structures valid for the same access unit. The syntax for indicating the AU view component order may be similar to those presented above.

In some embodiments, more than one AU view component order may be specified for example in a parameter set, such as a video parameter set or a sequence parameter set, for example using syntax similar to those presented above. Each order may be associated with an identifier, for example an integer value starting from 0 and incremented by 1 in the order the AU view component orders are specified in the parameter set. An AU view component order identifier value may be included for example in coded video sequence, GOP, or access unit level to indicate which AU view component order is in use for the respective coded video sequence, GOP, or access unit. The AU view component order identifier may be included for example in a picture parameter set, a GOS parameter set, an access unit delimiter, a picture header, a component picture delimiter, a component picture header, or a slice header. The AU view component order and hence the identifier value may be required to be identical in all syntax structures valid for the same access unit.

In some embodiments, the AU view component order may be specified for example in a parameter set or any other syntax structure such as those mentioned above with syntax and semantics that allow different AU view component orders to be used in the bitstream and thus in encoding and decoding. For example, an AU view component order may be specified with a list or a sequence of constraints capable of indicating for example that specific depth view components precede in AU view component order a particular texture view component. An item in the list or sequence of constraints may include a type of the constraint and indications of the concerned depth and texture view components. For example, the type of the constraint may indicate that depth view components are required to appear earlier than particular texture view component in AU view component order, and include a range or list of depth view components (e.g. their view order index values), and e.g. the view order index value of the texture view component. For example, it may be specified that in a stereoscopic depth-enhanced bitstream, both depth view components (D0 and D1) appear earlier than the non-base texture view component (T1) in an access unit. This constraint would suit/allow two AU view component orders: (D0, D1, T0, T1) and (T0, D0, D1, T1).

In some embodiments, the AU view component order may be implicitly indicated by the appearance order of view components in the bitstream.

The decoder may receive and decode indications of inter-view prediction hierarchies of texture and depth views from the bitstream for example as follows. The decoder may conclude one or more of the active video parameter set or similar, the active sequence parameter set(s) or similar, the active picture parameter set(s) or similar, and the active adaptation parameter set(s) or similar for example based on the parameter set identifiers included in one or more coded slice syntax structures being decoded. The inter-view prediction hierarchy may be present in one or more of these parameter set structures. In some embodiments, it is allowed to have the inter-view prediction hierarchy for texture views differing from that for depth views, and consequently the decoder may conclude that different parameter set or a different part of a parameter set is referred to from texture and depth views from which the inter-view dependency hierarchy may be decoded. In some embodiments, the inter-view prediction hierarchy of texture and depth views is indicated with the access unit and/or coded slice for example as view order index which may be present in an access unit delimiter, component picture delimiter, slice header, or anything alike, and the decoder may parse the inter-view prediction hierarchy information for example from the view order index syntax element or alike. In some embodiments, the inter-view prediction hierarchy may be indicated implicitly by the decoding/bitstream order of texture or depth view components within an access unit.

The decoder may receive and decode one or more indications of the AU view component order from the bitstream for example as follows. The indications of the AU view component order may be any of those mentioned above or any similar indications. The decoder may for example conclude which parameter set is active and decode the part of the active parameter set that indicates the AU view component order. In some embodiments, the decoder may decode an index of the AU view component order to be used for example from a picture parameter set and use the index to conclude which one of the AU view component orders included in an active video parameter set or sequence parameter is used for the access units referring to the picture parameter set.

In some embodiments, the decoder may use the decoded or concluded AU view component order for error resilience against transmission errors, corruption of mass memory medium, or anything alike as follows. The decoder may conclude that decoding of a new/next view component is started for example when the bitstream contains a component picture delimiter NAL unit, a component picture header, or a slice header indicating a different view order index and/or a different view component type (e.g. depth or texture) compared to the previous those of the previous slice. The decoder may compare the view component type and the indicator of the view component, such as the view order index, to those that the AU view component order infers for the next view component. If both the view component type and the indicator of the view component both match the ones expected based on the AU view component order, the decoder may conclude that no loss of an entire view component has happened. If either or both of the view component type and the indicator of the view component do not match with the ones expected based on the AU view component order, the decoder may conclude a loss of an entire view component. In some embodiments, more than one AU view component order is possible, and the decoder may therefore check if the next view component conforms to any of the possible AU view component orders. In some embodiments, the bitstream input to the decoder may have undergone bitstream extraction or pruning, while the indication of the AU view component order may reflect the bitstream prior to pruning. For example, in some embodiments, it may be possible to remove all depth view components from the bitstream, while the remaining bitstream is conforming, i.e. can be decoded. In some embodiments, the decoder may conclude whether a loss of a view component is/can be intentional or is/can be accidental for example based on indications whether inter-component coding tools are used and for which views they are or may be used. If the decoder concludes that a first view component is or may be required for a coding tool used in coding/decoding another view component, the decoder may conclude that a loss of the first view component is accidental.

In some embodiments, the same views are represented by texture view components and depth view components and there is a depth view component for each texture view component, both representing the same view. In some embodiments, there may be fewer depth view components than texture view components, while the present depth view components represent the same views as represented by some of the present texture view components.

Example embodiments of inferring the use of one or more coding tools, modes of coding tools, and/or coding parameters based on the AU view component order in the encoder and/or in the decoder are provided in the following paragraphs.

In some embodiments, one or more coding tools using inter-component dependency from depth to texture, such as D-MVP, depth-based intra prediction for texture, or JMVDC with depth in the base layer and texture in the enhancement layer, is used in encoding and decoding if the depth view component of a view precedes, in AU view component order, the texture view component of the same view. In some embodiments, if the depth view component of a view precedes, in AU view component order, the texture view component of the same view, the encoder indicates the use of one or more coding tools using inter-component dependency from depth to texture, such as D-MVP, depth-based intra prediction for texture, or JMVDC with depth in the base layer and texture in the enhancement layer, in the bitstream, while if the depth view component of a view succeeds, in AU view component order, the texture view component of the same view, the encoder does not indicate the use of one or more coding tools using inter-component dependency from depth to texture in the bitstream. The decoder concludes from the decoded AU view component order whether the indications of the one or more coding tools using inter-component dependency from depth to texture, such as D-MVP, are present in the bitstream, and if they are present, decodes them from the bitstream, and decodes the coded video data based on the concluded or decoded use of the depth-based texture coding tools.

In some embodiments, one or more coding tools using inter-component dependency from texture to depth, such as JMVDC with texture in the base layer and depth in the enhancement layer, is used in encoding and decoding if the texture view component of a view precedes, in AU view component order, the depth view component of the same view. In some embodiments, if the depth view component of a view succeeds, in AU view component order, the texture view component of the same view, the encoder indicates the use of one or more coding tools using inter-component dependency from texture to depth, such as JMVDC with texture in the base layer and depth in the enhancement layer, in the bitstream, while if the depth view component of a view precedes, in AU view component order, the texture view component of the same view, the encoder does not indicate the use of one or more coding tools using inter-component dependency from texture to depth in the bitstream. The decoder concludes from the decoded AU view component order whether the indications of the one or more coding tools using inter-component dependency from texture to depth are present in the bitstream, and if they are present, decodes them from the bitstream, and decodes the coded video data based on the concluded or decoded use of the texture-based depth coding tools.

In some embodiments, the encoder and decoder may conclude that if there are at least two depth view components consecutively in the AU view component order, the JVDF process or any other multiview depth filtering may be performed after reconstructing or decoding the last depth view component of such consecutive depth view components in the AU view component order. All the reconstructed or decoded depth view components up to the last one of the consecutive depth view components in AU view component order may take part in the JVDF process or alike. Consequently, the number of depth samples projected or warped to the same pixel or sample location may be greater than that resulting if JVDF or any other multiview depth filtering were applied after a smaller number, such as after each, depth view component had been reconstructed or decoded. Due to the greater number of depth samples mapped to the same pixel location, the filtering process may succeed better. For example, weighted averaging may be applied if a majority of depth/disparity values mapped to a pixel location fall into a confidence interval among those depth/disparity values only, thus outlier depth/disparity values may be excluded.

In some embodiments, the encoder may indicate with indication(s) in the bitstream that a coding tool is used when to a view component order associated or signaled with the coding tool is fulfilled. Otherwise, the coding tool may not be used. In other words, if a particular view component is encoded into the bitstream, if the earlier view components within the access unit enable the use of certain coding tool, and if the use of the coding tool is turned on with an indication, the encoder may use the coding tool for encoding the particular view component. For example, if a depth view component is being encoded, the texture view component of the same view as the depth view component being encoded has already been encoded, and the use IVMP has been enabled in the sequence parameter set or anything alike, the encoder may use IVMP to encode the current depth view component. The decoder may conclude the use of the coding tool respectively to the encoder. That is, if a particular view component is being decoded from the bitstream, if the earlier view components within the access unit enable the use of certain coding tool, and if the use of the coding tool is indicated in the bitstream, the decoder may use the coding tool for decoding the particular view component. For example, if a depth view component is being decoded, the texture view component of the same view as the depth view component being decoded has already been decoded, and the use IVMP has been enabled in the sequence parameter set or anything alike, the decoder may use IVMP to decode the current depth view component. In some embodiments, indication(s) in the bitstream that a coding tool is used may be specific to a particular indicated view component or to a set of particular indicated view components, while the indication(s) that the coding tool is used may be valid only when to a view component order associated or signaled with the coding tool is fulfilled for the indicated particular view components.

An example embodiment is described in the following in relation to 3DV-ATM. The NAL unit syntax of 3DV-ATM may be specified as follows. All coded slices for depth view components and 3DVC texture view components may use NAL unit type 21. Coded slices for depth views may either use the 3-byte NAL unit header MVC extension or the 2-byte NAL unit header 3DVC extension. Coded slices for 3DVC texture view components may use the 2-byte NAL unit header 3DVC extension. The NAL unit header 3DVC extension may be specified to be used for NAL unit type 21 when svc_extension_flag is equal to 1.

| | | | De- |
|---|---|---|---|
| | | | scrip- |
| nal_unit( NumBytesInNALunit ) { | | C | tor |
| | forbidden_zero_bit | Al | f(1) |
| | nal_ref_idc | Al | u(2) |
| | nal_unit_type | Al | u(5) |
| | NumBytesInRBSP = 0 | | |
| | nalUnitHeaderBytes = 1 | | |
| | if( nal_unit_type = = 14 \| \| nal_unit_type = = 20 \| \| | | |
| | nal_unit_type | | |

| | | |
|---|---|---|
| = = 21 ) { | | |
| svc_extension_flag | Al | u(1) |
| if( svc_extension_flag | | |

&& ( nal_unit_type = = 14 | |
nal_unit_type = = 20 ) ) {

| | |
|---|---|
| nal_unit_header_svc_extension( ) /* specified in | Al |
| Annex G */ | |
| nalUnitHeaderBytes += 3 | |
| } | |
| else if( svc_extension_flag && nal_unit_type = = | |
| 21 ) { | |
| nal_unit_header_3dvc_extension( ) /* specified in | |
| Annex I */ | |
| nalUnitHeaderBytes += 2 | |
| } | |
| else { | |
| nal_unit_header_mvc_extension( ) /* specified in | Al |
| Annex H */ | |
| nalUnitHeaderBytes += 3 | |
| } | |

}
for( i = nalUnitHeaderBytes; i < NumBytesInNALunit;
i++ ) {

| | | |
|---|---|---|
| if( i + 2 < NumBytesInNALunit && next_bits( 24 | | |
| ) = = 0x000003 | | |
| ) { | | |
| rbsp_byte[ NumBytesInRBSP++ ] | Al | b(8) |
| rbsp_byte[ NumBytesInRBSP++ ] | Al | b(8) |
| i += 2 | | |
| emulation_prevention_three_byte /* equal to | Al | f(8) |
| 0x03 */ | | |
| } else | | |
| rbsp_byte[ NumBytesInRBSP++ ] | Al | b(8) |

}

}

The NAL unit header 3DVC extension may be specified as follows. view_idx may specify the view order index for the NAL unit.

| | | |
|---|---|---|
| nal_unit_header_3dvc_extension( ) { | C | Descriptor |

| | | |
|---|---|---|
| view_idx | Al | u(8) |
| depth_flag | Al | u(1) |
| non_idr_flag | Al | u(1) |
| temporal_id | Al | u(3) |
| anchor_pic_flag | Al | u(1) |
| inter_view_flag | Al | u(1) |

}

The sequence parameter set syntax (or specifically the subset_seq_parameter_set_rbsp syntax) may be specified as follows. profile_idc equal to 138 may be used for the 3D High configuration and profile_idc equal to 139 may be used for the 3D Enhanced High configuration.

| | | |
|---|---|---|
| | | De- |
| | | scrip- |
| subset_seq_parameter_set_rbsp( ) { | C | tor |

| | |
|---|---|
| seq_parameter_set_data( ) | 0 |
| if( profile_idc = = 83 \| \| profile_idc = = 86 ) { | |

| | | |
|---|---|---|
| seq_parameter_set_svc_extension( ) /* specified | 0 | |
| in Annex G */ | | |
| svc_vui_parameters_present_flag | 0 | u(1) |
| if( svc_vui_parameters_present_flag = = 1 ) | | |
| svc_vui_parameters_extension( ) /* specified | 0 | |
| in Annex G */ | | |

} else if( profile_idc = = 118 | | profile_idc = = 128

| | profile_idc = = 138 | | profile_idc = = 139)
{

| | | |
|---|---|---|
| bit_equal_to_one /* equal to 1 */ | 0 | f(1) |
| seq_parameter_set_mvc_extension( ) /* specified | 0 | |
| in Annex H */ | | |
| mvc_vui_parameters_present_flag | 0 | u(1) |
| if( mvc_vui_parameters_present_flag = = 1 ) | | |
| mvc_vui_parameters_extension( ) /* specified | 0 | |
| in Annex H */ | | |

}
if( profile_idc = = 138 | | profile_idc = = 139 ) {

| | | |
|---|---|---|
| bit_equal_to_one /* equal to 1 */ | 0 | f(1) |
| seq_parameter_set_3dvc_extension( ) /* specified | 0 | |
| in Annex I */ | | |

| | | |
|---|---|---|
| } | | |
| additional_extension3_flag | 0 | u(1) |
| if( additional_extension3_flag = = 1 ) | | |

| | | |
|---|---|---|
| while( more_rbsp_data( ) ) | | |
| additional_extension3_data_flag | 0 | u(1) |

| | |
|---|---|
| rbsp_trailing_bits( ) | 0 |

}

The subset sequence parameter set RBSP may enable the use of the same subset sequence parameter set RBSP for all depth views and for those texture views that need not be marked compatible with single-view profiles of H.264/AVC. For example, the bitstream/decoding order of the depth view components in relation to texture view components may be indicated. This enables to derive the view component (bitstream/decoding) order of texture and depth view components within an access unit. The flags for turning on/off texture-based coding tools for texture (slice header prediction and IVMP) may apply only for those depth views that are preceded by the respective texture views.

seq_parameter_set_{—}3dvc_extension may be specified as follows:

| | | | De- |
|---|---|---|---|
| | | | scrip- |
| seq_parameter_set_3dvc_extension( ) { | | C | tor |
| | depth_info_present_flag | 0 | u(1) |
| | if( depth_info_present_flag ) { | | |

| | | |
|---|---|---|
| 3dv_acquisition_idc | 0 | ue(v) |
| if( ( 3dv_acquisition_idc ) && ( | | |
| num_views_minus1 > 0 ) ) | | |
| for( i = 0; i < num_views_minus1; i++ ) | | |

| | | |
|---|---|---|
| view_id_3dv[ i ] | 0 | ue(v) |

if( 3dv_acquisition_idc = = 1 | |
3dv_acquisition_idc = = 2 ) {
depth_ranges( 2, SPS )
if( profile_idc = = 139 )

vsp_param( 2, SPS )

| | | |
|---|---|---|
| } | | |
| for( i = 0 ; i <= num_views_minus_1; i++ ) | | |
| texture_voidx_delta[ i ] | 0 | ue(v) |

}
if( profile_idc = = 139 && depth_info_present_flag
) {

| | | |
|---|---|---|
| jvf_idc | 0 | u(2) |
| if( jvf_idc = = 1 ) | | |
| jvf_threshold | 0 | ue(v) |
| reduced_resolution_flag | 0 | u(1) |
| slice_header_prediction_idc | 0 | u(2) |
| inside_view_mvp_flag | 0 | u(1) |

}
if( profile_idc = = 139 && !depth_info_present_flag )

| | | |
|---|---|---|
| seq_view_synthesis_flag | 0 | u(1) |

}

}

The semantics of some syntax elements of the seq_parameter_set_{—}3dvc_extension may be specified as follows.

depth_info_present_flag equal to 0 specifies that no depth view components are present in a coded video sequence in which this subset sequence parameter set RBSP is active. depth_info_present_flag equal to 1 specifies that depth view components may be present in a coded video sequence in which this subset sequence parameter set RBSP is active.

texture_voidx_delta[i] specifies the decoding order of depth view components in relation to texture view components. The variables ViewCompOrderDepthFlag[idx] and ViewCompOrderVOIdx[idx] are specified as follows.

textureVOIdx = 0

depthVOIdx = 0
for( idx = 0; idx < (num_views_minus_1 + 1) * 2; ) {

for( idx2 = idx; idx2 < idx + texture_voidx_delta[ depthVOIdx
]; idx2++ ) {

ViewCompOrderDepthFlag[ idx2 ] = 0
ViewCompOrderVOIdx[ idx2 ] = textureVOIdx
textureVOIdx++

}
idx += texture_voidx_delta[ depthVOIdx ]
ViewCompOrderDepthFlag[ idx ] = 1
ViewCompOrderVOIdx[ idx ] = depthVOIdx
depthVOIdx++
idx++

}

The values of texture_voidx_delta[i] is such that the following constraint is true. Any view component with DepthFlag equal to ViewCompOrderDepthFlag[earlierIdx] and view order index equal to ViewCompOrderVOIdx[earlierIdx] with earlierIdx equal to any value in the range of 0 to num_views_minus1*2, inclusive, precedes in decoding order any view component with DepthFlag equal to ViewCompOrderDepthFlag[laterIdx] and view order index equal to ViewCompOrderVOIdx[laterIdx] with laterIdx equal to any value in the range of earlierIdx+1 to num_views_minus1*2+1, inclusive, when both the compared view components are present in the bitstream.

The function ViewCompOrder(depthFlag, vOIdx) is specified to return the value of idx for which ViewCompOrderDepthFlag[idx] is equal to depthFlag and ViewCompOrderVOIdx[idx] is equal to vOIdx.

slice_header_prediction_idc equal to 0 indicates that slice header prediction from texture view component to depth view component or vice versa is disallowed. slice_header_prediction_idc equal to 1 or 2 indicate that the prediction is used for the depth view components with view order index vOIdx when svc_extension_flag is equal to 1 and ViewCompOrder(0, vOIdx) is smaller than ViewCompOrder(1, vOIdx).

inside_view_mvp_flag equal to 1 indicates inside view motion prediction is enabled for depth view components having view order index vOIdx when svc_extension_flag is equal to 1 and ViewCompOrder(0, vOIdx) is smaller than ViewCompOrder(1, vOIdx). inside_view_mvp_flag equal to 0 inidicates that inside view motion prediction is disabled for all view components referring the current sequence parameter set.

In the slice header, indications related to coding tools dependent on a specific view component order between texture and depth views may be present only for those view components where the view component order suits the coding tool. For example, in 3DV-ATM the slice header prediction mechanism may only be available for depth view components that use the NAL unit header 3DVC extension (for which svc_extension_flag is equal to 1) and are preceded by the respective texture view components. Furthermore, dmvp_flag indicating the use of the D-MVP tool may be present only for 3DVC texture view components that are preceded by the respective depth view components. The respective slice header syntax may be illustrated for example as follows.

| | | | De- |
|---|---|---|---|
| | | | scrip- |
| slice_header( ) { | | C | tor |
| | first_mb_in_slice | 2 | ue(v) |
| | slice_type | 2 | ue(v) |
| | pic_parameter_set_id | 2 | ue(v) |
| | if( DepthFlag && | | |

ViewCompOrder( 0, view_idx ) <
ViewCompOrder( 1, view_idx

) &&

svc_extension_flag &&
slice_header_prediction_idc != 0 ) {

... /* slice header prediction used */

}
...

if ( nal_unit_type = = 21 && ( slice_type != I &&
slice_type !=
SI )) {
if( DepthFlag )

| | | |
|---|---|---|
| depth_weighted_pred_flag | 2 | u(1) |

else if( svc_extension_flag &&

ViewCompOrder( 0, view_idx ) >
ViewCompOrder( 1,

view_idx ) )

| | | |
|---|---|---|
| dmvp_flag | 2 | u(1) |

}

}

}

In 3DV-ATM, the variable IvmpEnabledFlag may be used in the macroblock_layer syntax to control if the mb_ivmp_flag is present. mb_ivmp_flag may indicate whether or not IVMP is used for the current macroblock (specified in its coded form by the macroblock_layer syntax structure). The derivation of the value of IvmpEnabledFlag may be performed as follows. IvmpEnabledFlag is set to 1 when all of the following conditions are satisfied:
inside_view_mvp_flag is equal to 1 (inside view motion prediction is enabled);
the current view component is a depth view component;
ViewCompOrder(0, view_idx) is smaller than ViewCompOrder(1, view_idx);
svc_extension_flag is equal to 1;
the current picture is a non-anchor picture and the slice type is not I or SI slice.

Otherwise, IvmpEnabledFlag is set to 0.

In the above, some embodiments have been described in relation to particular types of parameter sets. It needs to be understood, however, that embodiments could be realized with any type of parameter set or other syntax structure in the bitstream.

In the above, some embodiments have been described in relation to particular types of component pictures, namely depth view components and texture view components. In needs to be understood, however, that embodiments could be realized with any types of component pictures, which may be present in the bitstream instead of or in addition to texture and depth view components. For example, a component picture in some embodiments could comprise an infrared view component or some other image representation that falls outside of the conventional radio frequency spectrum used to represent human-perceivable images.

In the above, some embodiments have been described in relation to coding/decoding methods or tools having inter-component dependency, such as depth-based texture coding/decoding or prediction tools. It needs to be understood that embodiments may not be specific to the described coding/decoding methods but could be realized with any similar coding/decoding methods or tools.

In the above, the example embodiments have been described with the help of syntax of the bitstream. It needs to be understood, however, that the corresponding structure and/or computer program may reside at the encoder for generating the bitstream and/or at the decoder for decoding the bitstream. Likewise, where the example embodiments have been described with reference to an encoder, it needs to be understood that the resulting bitstream and the decoder have corresponding elements in them. Likewise, where the example embodiments have been described with reference to a decoder, it needs to be understood that the encoder has structure and/or computer program for generating the bitstream to be decoded by the decoder.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatuses, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys Inc., of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example there is provided a method comprising:
obtaining at least one view component of a first type and at least one view component of a second type of a view;
determining a view component order of the at least one view component of the first type and the at least one view component of the second type in an access unit;
encoding at least one indication of the view component order; and
adapting coding of one or both of the at least one view component of the first type and the at least one view component of the second type on the basis of the view component order.

In some embodiments the first type is a texture view component; and the second type is a depth view component.

In some embodiments the first type is an infrared view component.

In some embodiments the adapting coding comprises selecting at least one of the following for encoding:
a coding tool among a set of coding tools;
a coding mode among a set of coding modes; one or more coding parameters.

In some embodiments the view component order is indicated in an access unit level.

In some embodiments the access unit level is one of the following:
a picture parameter set;
an adaptation parameter set;
an access unit delimiter.

In some embodiments the view component order is indicated in a level below the access unit level.

In some embodiments the level below the access unit level is one of the following:
a group of slices parameter set;
a picture header;
a component picture delimiter;
a component picture header;
a slice header.

In some embodiments the view component order is identical in all syntax structures valid for the same access unit.

In some embodiments the at least one indication of the order is encoded in at least one of the following:
a group of slices parameter set syntax structure;
a video parameter set;
a sequence parameter set.

In some embodiments a number of texture view components and depth view components are obtained for a multiple of views, wherein the method further comprises defining a view order index for the view components.

In some embodiments the at least one indication indicates how depth view components are located or interleaved in relation to the texture view components, which appear in the access unit in an order determined by their view order index.

In some embodiments the method comprises defining a set of view component orders in a parameter set;
defining an identifier value for each view component order in the parameter set; and
encoding an active identifier value corresponding to the selected view component order.

In some embodiments the depth view component is encoded before the respective texture view component of the same view.

In some embodiments the depth view component of a view precedes in the view component order the texture view component of the same view, wherein the adapting coding comprises at least one of:
selecting a coding tool which uses inter-component dependency from the depth view component to the texture view component;
encoding an indication of the selected coding tool;
providing the depth view component in a base layer and providing the texture view component in an enhancement layer.

In some embodiments the depth view component of a view succeeds in access unit view component order the texture view component of the same view, wherein the adapting coding comprises at least one of:
selecting a coding tool which uses inter-component dependency from the texture view component to the depth view component;
encoding a second indication indicative of the selected coding tool; providing the texture view component in a base layer and providing the depth view component in an enhancement layer.

According to a second example there is provided an apparatus comprising at least one processor and at least one memory including computer program code, the at least one memory and the computer program code configured to, with the at least one processor, cause the apparatus to:
obtain at least one view component of a first type and at least one view component of a second type of a view;
determine a view component order of the at least one view component of the first type and the at least one view component of the second type in an access unit;
encode at least one indication of the view component order; and
adapt coding of one or both of the at least one view component of the first type and the at least one view component of the second type on the basis of the view component order.

In some embodiments of the apparatus the first type is a texture view component; and the second type is a depth view component.

In some embodiments of the apparatus the first type is an infrared view component.

In some embodiments of the apparatus said at least one memory stored with code thereon, which when executed by said at least one processor, further causes the apparatus to select at least one of the following for encoding:
a coding tool among a set of coding tools;
a coding mode among a set of coding modes;
one or more coding parameters.

In some embodiments of the apparatus said at least one memory stored with code thereon, which when executed by said at least one processor, further causes the apparatus to indicate the view component order in an access unit level.

In some embodiments of the apparatus the access unit level is one of the following:
a picture parameter set;
an adaptation parameter set;
an access unit delimiter.

In some embodiments of the apparatus said at least one memory stored with code thereon, which when executed by said at least one processor, further causes the apparatus to indicate the view component order in a level below the access unit level.

In some embodiments of the apparatus the level below the access unit level is one of the following:
a group of slices parameter set;
a picture header;
a component picture delimiter;
a component picture header;
a slice header.

In some embodiments of the apparatus the view component order is identical in all syntax structures valid for the same access unit.

In some embodiments of the apparatus said at least one memory stored with code thereon, which when executed by said at least one processor, further causes the apparatus to encode the at least one indication of the order in at least one of the following:
a group of slices parameter set syntax structure;
a video parameter set;
a sequence parameter set.

In some embodiments of the apparatus said at least one memory stored with code thereon, which when executed by said at least one processor, further causes the apparatus to obtain a number of texture view components and depth view components for a multiple of views, and to define a view order index for the view components.

In some embodiments of the apparatus the at least one indication indicates how depth view components are located or interleaved in relation to the texture view components, which appear in the access unit in an order determined by their view order index.

In some embodiments of the apparatus said at least one memory stored with code thereon, which when executed by said at least one processor, further causes the apparatus to
define a set of view component orders in a parameter set;
define an identifier value for each view component order in the parameter set; and
encode an active identifier value corresponding to the selected view component order.

In some embodiments of the apparatus said at least one memory stored with code thereon, which when executed by said at least one processor, further causes the apparatus to encode the depth view component before the respective texture view component of the same view.

In some embodiments of the apparatus the depth view component of a view precedes in the view component order the texture view component of the same view, wherein said at least one memory stored with code thereon, which when executed by said at least one processor, further causes the apparatus to perform at least one of:
selecting a coding tool which uses inter-component dependency from the depth view component to the texture view component;
encoding an indication of the selected coding tool;
providing the depth view component in a base layer and providing the texture view component in an enhancement layer.

In some embodiments the depth view component of a view succeeds in access unit view component order the texture view component of the same view, wherein said at least one memory stored with code thereon, which when executed by said at least one processor, further causes the apparatus to perform at least one of:
selecting a coding tool which uses inter-component dependency from the texture view component to the depth view component;
encoding a second indication indicative of the selected coding tool;
providing the texture view component in a base layer and providing the depth view component in an enhancement layer.

In some embodiments of the apparatus the view components belong to a multiview video.

In some embodiments the apparatus is a component of a mobile station.

According to a third example there is provided a computer program product including one or more sequences of one or more instructions which, when executed by one or more processors, cause an apparatus to at least perform the following:
obtain at least one view component of a first type and at least one view component of a second type of a view;
determine a view component order of the at least one view component of the first type and the at least one view component of the second type in an access unit;
encode at least one indication of the view component order; and
adapt coding of one or both of the at least one view component of the first type and the at least one view component of the second type on the basis of the view component order.

In some embodiments of the computer program product the first type is a texture view component; and the second type is a depth view component.

In some embodiments of the computer program product the first type is an infrared view component.

In some embodiments the computer program product includes one or more sequences of one or more instructions which, when executed by one or more processors, cause the apparatus to select at least one of the following for encoding:
a coding tool among a set of coding tools;
a coding mode among a set of coding modes;
one or more coding parameters.

In some embodiments the computer program product includes one or more sequences of one or more instructions which, when executed by one or more processors, cause the apparatus to indicate the view component order in an access unit level.

In some embodiments of the computer program product the access unit level is one of the following:
a picture parameter set;
an adaptation parameter set;
an access unit delimiter.

In some embodiments the computer program product includes one or more sequences of one or more instructions which, when executed by one or more processors, cause the apparatus to indicate the view component order in a level below the access unit level.

In some embodiments of the computer program product the level below the access unit level is one of the following:
a group of slices parameter set;
a picture header;
a component picture delimiter;
a component picture header;
a slice header.

In some embodiments of the computer program product the view component order is identical in all syntax structures valid for the same access unit.

In some embodiments the computer program product includes one or more sequences of one or more instructions which, when executed by one or more processors, cause the apparatus to encode the at least one indication of the order in at least one of the following:
a group of slices parameter set syntax structure;
a video parameter set;
a sequence parameter set.

In some embodiments the computer program product includes one or more sequences of one or more instructions which, when executed by one or more processors, cause the apparatus to obtain a number of texture view components and depth view components for a multiple of views, and to define a view order index for the view components.

In some embodiments of the computer program product the at least one indication indicates how depth view components are located or interleaved in relation to the texture view components, which appear in the access unit in an order determined by their view order index.

In some embodiments the computer program product includes one or more sequences of one or more instructions which, when executed by one or more processors, cause the apparatus to:
define a set of view component orders in a parameter set;
define an identifier value for each view component order in the parameter set; and
encode an active identifier value corresponding to the selected view component order.

In some embodiments the computer program product includes one or more sequences of one or more instructions which, when executed by one or more processors, cause the apparatus to encode the depth view component before the respective texture view component of the same view.

In some embodiments of the computer program product the depth view component of a view precedes in the view component order the texture view component of the same view, wherein the computer program product includes one or more sequences of one or more instructions which, when executed by one or more processors, cause the apparatus to perform at least one of:
selecting a coding tool which uses inter-component dependency from the depth view component to the texture view component;
encoding an indication of the selected coding tool;
providing the depth view component in a base layer and providing the texture view component in an enhancement layer.

In some embodiments of the computer program product the depth view component of a view succeeds in access unit view component order the texture view component of the same view, wherein the computer program product includes one or more sequences of one or more instructions which, when executed by one or more processors, cause the apparatus to perform at least one of:
selecting a coding tool which uses inter-component dependency from the texture view component to the depth view component;
encoding a second indication indicative of the selected coding tool;
providing the texture view component in a base layer and providing the depth view component in an enhancement layer.

In some embodiments of the computer program product the view components belong to a multiview video.

In some embodiments of the computer program product is a software component of a mobile station.

According to a fourth example there is provided an apparatus comprising:
means for obtaining at least one view component of a first type and at least one view component of a second type of a view;
means for determining a view component order of the at least one view component of the first type and the at least one view component of the second type in an access unit;
means for encoding at least one indication of the view component order; and
means for adapting coding of one or both of the at least one view component of the first type and the at least one view component of the second type on the basis of the view component order.

In some embodiments of the apparatus the first type is a texture view component; and the second type is a depth view component.

In some embodiments of the apparatus the first type is an infrared view component.

In some embodiments the apparatus comprises means for selecting at least one of the following for encoding:
a coding tool among a set of coding tools;
a coding mode among a set of coding modes;
one or more coding parameters.

In some embodiments the apparatus comprises means for indicating the view component order in an access unit level.

In some embodiments of the apparatus the access unit level is one of the following:
a picture parameter set;
an adaptation parameter set;
an access unit delimiter.

In some embodiments the apparatus comprises means for indicating the view component order in a level below the access unit level.

In some embodiments of the apparatus the level below the access unit level is one of the following:
a group of slices parameter set;
a picture header;
a component picture delimiter;
a component picture header;
a slice header.

In some embodiments of the apparatus the view component order is identical in all syntax structures valid for the same access unit.

In some embodiments the apparatus comprises means for encoding the at least one indication of the order in at least one of the following:
a group of slices parameter set syntax structure;
a video parameter set;
sequence parameter set.

In some embodiments the apparatus comprises means for obtaining a number of texture view components and depth view components for a multiple of views, and means for defining a view order index for the view components.

In some embodiments of the apparatus the at least one indication indicates how depth view components are located or interleaved in relation to the texture view components, which appear in the access unit in an order determined by their view order index.

In some embodiments the apparatus comprises:
means for defining a set of view component orders in a parameter set;
means for defining an identifier value for each view component order in the parameter set; and
means for encoding an active identifier value corresponding to the selected view component order.

In some embodiments the apparatus comprises means for encoding the depth view component before the respective texture view component of the same view.

In some embodiments the depth view component of a view precedes in the view component order the texture view component of the same view, wherein the apparatus comprises means for performing at least one of:
selecting a coding tool which uses inter-component dependency from the depth view component to the texture view component;
encoding an indication of the selected coding tool;
providing the depth view component in a base layer and providing the texture view component in an enhancement layer.

In some embodiments the depth view component of a view succeeds in access unit view component order the texture view component of the same view, wherein the apparatus comprises means for performing at least one of:
selecting a coding tool which uses inter-component dependency from the texture view component to the depth view component;
encoding a second indication indicative of the selected coding tool;
providing the texture view component in a base layer and providing the depth view component in an enhancement layer.

In some embodiments of the apparatus the view components belong to a multiview video.

In some embodiments the apparatus is a component of a mobile station.

According to a fifth example there is provided a method comprising:
receiving at least one encoded view component of a first type and at least one encoded view component of a second type of a view;
receiving at least one encoded indication of a view component order of the at least one view component of the first type and the at least one view component of the second type; and
decoding the at least one encoded indication of the view component order; and
adapting decoding of one or both of the at least one view component of the first type and the at least one view component of the second type on the basis of the view component order.

In some embodiments the first type is a texture view component; and the second type is a depth view component.

In some embodiments the first type is an infrared view component.

In some embodiments the adapting decoding comprises selecting at least one of the following for decoding:
a decoding tool among a set of decoding tools;
a decoding mode among a set of decoding modes;
one or more decoding parameters.

In some embodiments the view component order is indicated in an access unit level.

In some embodiments the access unit level is one of the following:
a picture parameter set;
an adaptation parameter set;
an access unit delimiter.

In some embodiments the view component order is indicated in a level below the access unit level.

In some embodiments the level below the access unit level is one of the following:
a group of slices parameter set;
a picture header;
a component picture delimiter;
a component picture header;
a slice header.

In some embodiments the view component order is identical in all syntax structures valid for the same access unit.

In some embodiments the at least one indication of the order is decoded in at least one of the following:
a group of slices parameter set syntax structure;
a video parameter set;
sequence parameter set.

In some embodiments a number of texture view components and depth view components are obtained for a multiple of views, wherein the method further comprises decoding a view order index for the view components.

In some embodiments the at least one indication indicates how depth view components are located or interleaved in relation to the texture view components, which appear in the access unit in an order determined by their view order index.

In some embodiments the method comprises:
defining a set of view component orders in a parameter set;
receiving an identifier value for each view component order in the parameter set; and
decoding an active identifier value corresponding to the selected view component order.

In some embodiments the depth view component is decoded before the respective texture view component of the same view.

In some embodiments the depth view component of a view precedes in the view component order the texture view component of the same view, wherein the adapting decoding comprises at least one of:
selecting a decoding tool which uses inter-component dependency from the depth view component to the texture view component;
encoding an indication of the selected coding tool; and
receiving the depth view component in a base layer and receiving the texture view component in an enhancement layer.

In some embodiments the depth view component of a view succeeds in access unit view component order the texture view component of the same view, wherein the adapting decoding comprises at least one of:
selecting a decoding tool which uses inter-component dependency from the texture view component to the depth view component; and
decoding a second indication indicative of the selected coding tool; and
receiving the depth view component in a base layer and receiving the texture view component in an enhancement layer.

In some embodiments the method comprises determining the order of the texture view component and the depth view component in an access unit on the basis of the decoded indication.

According to a sixth example there is provided an apparatus comprising at least one processor and at least one memory including computer program code, the at least one memory and the computer program code configured to, with the at least one processor, cause the apparatus to:
receive at least one view component of a first type and at least one view component of a second type of a view;
receive at least one encoded indication of a view component order of the at least one view component of the first type and the at least one view component of the second type;
decode the at least one encoded indication of the view component order; and
adapt decoding of one or both of the at least one view component of the first type and the at least one view component of the second type on the basis of the view component order.

In some embodiments of the apparatus the first type is a texture view component; and the second type is a depth view component.

In some embodiments of the apparatus the first type is an infrared view component.

In some embodiments of the apparatus said at least one memory stored with code thereon, which when executed by said at least one processor, further causes the apparatus to select at least one of the following for decoding:
a decoding tool among a set of decoding tools;
a decoding mode among a set of decoding modes;
one or more decoding parameters.

In some embodiments of the apparatus said at least one memory stored with code thereon, which when executed by said at least one processor, further causes the apparatus to indicate the view component order in an access unit level.

In some embodiments of the apparatus the access unit level is one of the following:
a picture parameter set;
an adaptation parameter set;
an access unit delimiter.

In some embodiments of the apparatus said at least one memory stored with code thereon, which when executed by said at least one processor, further causes the apparatus to indicate the view component order in a level below the access unit level.

In some embodiments of the apparatus the level below the access unit level is one of the following:
a group of slices parameter set;
a picture header;
a component picture delimiter;
a component picture header;
a slice header.

In some embodiments of the apparatus the view component order is identical in all syntax structures valid for the same access unit.

In some embodiments of the apparatus said at least one memory stored with code thereon, which when executed by said at least one processor, further causes the apparatus to decode the at least one indication of the order in at least one of the following:
a group of slices parameter set syntax structure;
a video parameter set;
sequence parameter set.

In some embodiments of the apparatus said at least one memory stored with code thereon, which when executed by said at least one processor, further causes the apparatus to obtain a number of texture view components and depth view components for a multiple of views, and to decode a view order index for the view components.

In some embodiments of the apparatus the at least one indication indicates how depth view components are located or interleaved in relation to the texture view components, which appear in the access unit in an order determined by their view order index.

In some embodiments of the apparatus said at least one memory stored with code thereon, which when executed by said at least one processor, further causes the apparatus to:
define a set of view component orders in a parameter set;
receive an identifier value for each view component order in the parameter set; and
decode an active identifier value corresponding to the selected view component order.

In some embodiments of the apparatus said at least one memory stored with code thereon, which when executed by said at least one processor, further causes the apparatus to decode the depth view component before the respective texture view component of the same view.

In some embodiments of the apparatus the depth view component of a view precedes in the view component order the texture view component of the same view, said at least one memory stored with code thereon, which when executed by said at least one processor, further causes the apparatus to perform at least one of:
selecting a decoding tool which uses inter-component dependency from the depth view component to the texture view component;
encoding an indication of the selected coding tool; and
receiving the depth view component in a base layer and receiving the texture view component in an enhancement layer.

In some embodiments of the apparatus the depth view component of a view succeeds in access unit view component order the texture view component of the same view, said at least one memory stored with code thereon, which when executed by said at least one processor, further causes the apparatus to perform at least one of:
selecting a decoding tool which uses inter-component dependency from the texture view component to the depth view component; and
decoding a second indication indicative of the selected coding tool; and
receiving the depth view component in a base layer and receiving the texture view component in an enhancement layer.

In some embodiments of the apparatus said at least one memory stored with code thereon, which when executed by said at least one processor, further causes the apparatus to determine the order of the texture view component and the depth view component in an access unit on the basis of the decoded indication.

In some embodiments of the apparatus the view components belong to a multiview video.

In some embodiments the apparatus is a component of a mobile station.

According to a seventh example there is provided a computer program product including one or more sequences of one or more instructions which, when executed by one or more processors, cause an apparatus to at least perform the following:
receive at least one view component of a first type and at least one view component of a second type of a view;
receive at least one encoded indication of a view component order of the at least one view component of the first type and the at least one view component of the second type;
decode the at least one encoded indication of the view component order; and
adapt decoding of one or both of the at least one view component of the first type and the at least one view component of the second type on the basis of the view component order.

In some embodiments of the computer program product the first type is a texture view component; and the second type is a depth view component.

In some embodiments of the computer program product the first type is an infrared view component.

In some embodiments the computer program product includes one or more sequences of one or more instructions which, when executed by one or more processors, further causes the apparatus to select at least one of the following for decoding:
a decoding tool among a set of decoding tools;
a decoding mode among a set of decoding modes;
one or more decoding parameters.

In some embodiments the computer program product includes one or more sequences of one or more instructions which, when executed by one or more processors, further causes the apparatus to indicate the view component order in an access unit level.

In some embodiments of the computer program product the access unit level is one of the following:
a picture parameter set;
an adaptation parameter set;
an access unit delimiter.

In some embodiments the computer program product includes one or more sequences of one or more instructions which, when executed by one or more processors, further causes the apparatus to indicate the view component order in a level below the access unit level.

In some embodiments of the computer program product the level below the access unit level is one of the following:
a group of slices parameter set;
a picture header;
a component picture delimiter;
a component picture header;
a slice header.

In some embodiments of the computer program product the view component order is identical in all syntax structures valid for the same access unit.

In some embodiments the computer program product includes one or more sequences of one or more instructions which, when executed by one or more processors, further causes the apparatus to decode the at least one indication of the order in at least one of the following:
a group of slices parameter set syntax structure;
a video parameter set;
sequence parameter set.

In some embodiments the computer program product includes one or more sequences of one or more instructions which, when executed by one or more processors, further causes the apparatus to obtain a number of texture view components and depth view components for a multiple of views, and to decode a view order index for the view components.

In some embodiments of the computer program product the at least one indication indicates how depth view components are located or interleaved in relation to the texture view components, which appear in the access unit in an order determined by their view order index.

In some embodiments the computer program product includes one or more sequences of one or more instructions which, when executed by one or more processors, further causes the apparatus to:
define a set of view component orders in a parameter set;
receive an identifier value for each view component order in the parameter set; and
decode an active identifier value corresponding to the selected view component order.

In some embodiments the computer program product includes one or more sequences of one or more instructions which, when executed by one or more processors, further causes the apparatus to decode the depth view component before the respective texture view component of the same view.

In some embodiments the depth view component of a view precedes in the view component order the texture view component of the same view, wherein the computer program product includes one or more sequences of one or more instructions which, when executed by one or more processors, further causes the apparatus to perform at least one of:
selecting a decoding tool which uses inter-component dependency from the depth view component to the texture view component;
encoding an indication of the selected coding tool; and
receiving the depth view component in a base layer and receiving the texture view component in an enhancement layer.

In some embodiments the depth view component of a view succeeds in access unit view component order the texture view component of the same view, wherein > the computer program product includes one or more sequences of one or more instructions which, when executed by one or more processors, further causes the apparatus to perform at least one of:
selecting a decoding tool which uses inter-component dependency from the texture view component to the depth view component; and
decoding a second indication indicative of the selected coding tool; and
receiving the depth view component in a base layer and receiving the texture view component in an enhancement layer.

In some embodiments the computer program product includes one or more sequences of one or more instructions which, when executed by one or more processors, further causes the apparatus to determine the order of the texture view component and the depth view component in an access unit on the basis of the decoded indication.

In some embodiments of the computer program product the view components belong to a multiview video.

In some embodiments of the computer program product is a software component of a mobile station.

According to an eighth example there is provided an apparatus comprising:
means for receiving at least one encoded view component of a first type and at least one encoded view component of a second type of a view;
means for receiving at least one encoded indication of a view component order of the at least one view component of the first type and the at least one view component of the second type; and
means for decoding the at least one encoded indication of the view component order; and
means for adapting decoding of one or both of the at least one view component of the first type and the at least one view component of the second type on the basis of the view component order.

In some embodiments of the apparatus the first type is a texture view component; and the second type is a depth view component.

In some embodiments of the apparatus the first type is an infrared view component.

In some embodiments the apparatus comprises means for selecting at least one of the following for decoding:
a decoding tool among a set of decoding tools;
a decoding mode among a set of decoding modes;
one or more decoding parameters.

In some embodiments the apparatus comprises means for indicating the view component order in an access unit level.

In some embodiments of the apparatus the access unit level is one of the following:
a picture parameter set;
an adaptation parameter set;
an access unit delimiter.

In some embodiments the apparatus comprises means for indicating the view component order in a level below the access unit level.

In some embodiments of the apparatus the level below the access unit level is one of the following:
a group of slices parameter set;
a picture header;
a component picture delimiter;
a component picture header;
a slice header.

In some embodiments of the apparatus the view component order is identical in all syntax structures valid for the same access unit.

In some embodiments the apparatus comprises means for decoding the at least one indication of the order in at least one of the following:
a group of slices parameter set syntax structure;
a video parameter set;
sequence parameter set.

In some embodiments the apparatus comprises means for obtaining a number of texture view components and depth view components for a multiple of views, and means for decoding a view order index for the view components.

In some embodiments of the apparatus the at least one indication indicates how depth view components are located or interleaved in relation to the texture view components, which appear in the access unit in an order determined by their view order index.

In some embodiments the apparatus comprises:
means for defining a set of view component orders in a parameter set;
means for receiving an identifier value for each view component order in the parameter set; and
means for decoding an active identifier value corresponding to the selected view component order.

In some embodiments the apparatus comprises means for decoding the depth view component before the respective texture view component of the same view.

In some embodiments the depth view component of a view precedes in the view component order the texture view component of the same view, wherein the apparatus comprises means for performing at least one of:
selecting a decoding tool which uses inter-component dependency from the depth view component to the texture view component;
encoding an indication of the selected coding tool; and
receiving the depth view component in a base layer and receiving the texture view component in an enhancement layer.

In some embodiments the depth view component of a view succeeds in access unit view component order the texture view component of the same view, wherein the apparatus comprises means for performing at least one of:
selecting a decoding tool which uses inter-component dependency from the texture view component to the depth view component; and
decoding a second indication indicative of the selected coding tool; and
receiving the depth view component in a base layer and receiving the texture view component in an enhancement layer.

In some embodiments the apparatus comprises means for determining the order of the texture view component and the depth view component in an access unit on the basis of the decoded indication.

In some embodiments of the apparatus the view components belong to a multiview video.

In some embodiments the apparatus is a component of a mobile station.

We claim:

1. A method comprising:
obtaining at least one view component of a first type and at least one view component of a second type;
determining a view component order of the at least one view component of the first type and the at least one view component of the second type in an access unit;
encoding at least one indication of the view component order; and
adapting coding of one or both of the at least one view component of the first type and the at least one view component of the second type on the basis of the view component order, wherein said adapting comprises selecting at least one of the following for encoding:
a coding tool among a set of coding tools;
a coding mode among a set of coding modes;
one or more coding parameters.

2. The method according to claim 1, wherein the at least one indication of the view component order is encoded in at least one of the following:
a group of slices parameter set syntax structure;
a video parameter set;
a sequence parameter set.

3. The method according to claim 1, wherein the second type is a depth view component; and the first type is a texture view component; and the at least one indication indicates how depth view components are located or interleaved in relation to the texture view components, which appear in the access unit in an order determined by their view order index.

4. The method according to claim 3, wherein the depth view component of a view precedes in the view component order the texture view component of the same view, wherein the adapting coding comprises at least one of:
selecting a coding tool which uses inter-component dependency from the depth view component to the texture view component;
encoding an indication of the selected coding tool;
providing the depth view component in a base layer and providing the texture view component in an enhancement layer.

5. The method according to claim 3, wherein the depth view component of a view succeeds in access unit view component order the texture view component of the same view, wherein the adapting coding comprises at least one of:
selecting a coding tool which uses inter-component dependency from the texture view component to the depth view component;
encoding a second indication indicative of the selected coding tool;
providing the texture view component in a base layer and providing the depth view component in an enhancement layer.

6. An apparatus comprising at least one processor and at least one memory including computer program code, the at least one memory and the computer program code configured to, with the at least one processor, cause the apparatus to:
obtain at least one view component of a first type and at least one view component of a second type;
determine a view component order of the at least one view component of the first type and the at least one view component of the second type in an access unit;
encode at least one indication of the view component order; and
adapt coding of one or both of the at least one view component of the first type and the at least one view component of the second type on the basis of the view component order by selecting at least one of the following for encoding:
a coding tool among a set of coding tools;
a coding mode among a set of coding modes;
one or more coding parameters.

7. The apparatus according to claim 6, said at least one memory stored with code thereon, which when executed by said at least one processor, further causes the apparatus to encode the at least one indication of the view component order in at least one of the following:
a group of slices parameter set syntax structure;
a video parameter set;
a sequence parameter set.

8. The apparatus according to claim 6, wherein the second type is a depth view component; and the first type is a texture view component; and the at least one indication indicates how depth view components are located or interleaved in relation to the texture view components, which appear in the access unit in an order determined by their view order index.

9. The apparatus according to claim 8, the depth view component of a view precedes in the view component order the texture view component of the same view, wherein said at least one memory stored with code thereon, which when executed by said at least one processor, further causes the apparatus to perform at least one of:
selecting a coding tool which uses inter-component dependency from the depth view component to the texture view component;
encoding an indication of the selected coding tool;
providing the depth view component in a base layer and providing the texture view component in an enhancement layer.

10. The apparatus according to claim 8, wherein the depth view component of a view succeeds in access unit view component order the texture view component of the same view, wherein said at least one memory stored with code thereon, which when executed by said at least one processor, further causes the apparatus to perform at least one of:
selecting a coding tool which uses inter-component dependency from the texture view component to the depth view component;
encoding a second indication indicative of the selected coding tool;
providing the texture view component in a base layer and providing the depth view component in an enhancement layer.

11. An apparatus comprising:
means for obtaining at least one view component of a first type and at least one view component of a second type;
means for determining a view component order of the at least one view component of the first type and the at least one view component of the second type in an access unit;
means for encoding at least one indication of the view component order; and
means for adapting coding of one or both of the at least one view component of the first type and the at least one view component of the second type on the basis of the view component order, wherein said means for adapting comprises means for selecting at least one of the following for encoding:
a coding tool among a set of coding tools;
a coding mode among a set of coding modes;
one or more coding parameters.

12. A method comprising:
receiving at least one encoded view component of a first type and at least one encoded view component of a second type;
receiving at least one encoded indication of a view component order of the at least one view component of the first type and the at least one view component of the second type; and
decoding the at least one encoded indication of the view component order; and
adapting decoding of one or both of the at least one view component of the first type and the at least one view component of the second type on the basis of the view component order, wherein said adapting comprises selecting at least one of the following for decoding:
a decoding tool among a set of decoding tools;
a decoding mode among a set of decoding modes;
one or more decoding parameters.

13. The method according to claim 12, wherein the at least one indication of the view component order is decoded from at least one of the following:
a group of slices parameter set syntax structure;
a video parameter set;
a sequence parameter set.

14. The method according to claim 12, wherein the second type is a depth view component;
and the first type is a texture view component; and the at least one indication indicates how depth view components are located or interleaved in relation to the texture view components, which appear in the access unit in an order determined by their view order index.

15. The method according to claim 14, wherein the depth view component of a view precedes in the view component order the texture view component of the same view, wherein the adapting decoding comprises at least one of:
selecting a decoding tool which uses inter-component dependency from the depth view component to the texture view component;
encoding an indication of the selected decoding tool; and
receiving the depth view component in a base layer and receiving the texture view component in an enhancement layer.

16. The method according to claim 14, wherein the depth view component of a view succeeds in access unit view component order the texture view component of the same view, wherein the adapting decoding comprises at least one of:
selecting a decoding tool which uses inter-component dependency from the texture view component to the depth view component; and
decoding a second indication indicative of the selected decoding tool; and
receiving the depth view component in a base layer and receiving the texture view component in an enhancement layer.

17. An apparatus comprising at least one processor and at least one memory including computer program code, the at least one memory and the computer program code configured to, with the at least one processor, cause the apparatus to:
receive at least one view component of a first type and at least one view component of a second type;
receive at least one encoded indication of a view component order of the at least one view component of the first type and the at least one view component of the second type;
decode the at least one encoded indication of the view component order; and
adapt decoding of one or both of the at least one view component of the first type and the at least one view component of the second type on the basis of the view component order by selecting at least one of the following for decoding:
a decoding tool among a set of decoding tools;
a decoding mode among a set of decoding modes;
one or more decoding parameters.

18. The apparatus according to claim 17, said at least one memory stored with code thereon, which when executed by said at least one processor, further causes the apparatus to decode the at least one indication of the view component order from at least one of the following:
a group of slices parameter set syntax structure;
a video parameter set;
a sequence parameter set.

19. The apparatus according to claim 17, wherein the second type is a depth view component; and the first type is a texture view component; and the at least one indication indicates how depth view components are located or interleaved in relation to the texture view components, which appear in the access unit in an order determined by their view order index.

20. The apparatus according to claim 19, wherein the depth view component of a view precedes in the view component order the texture view component of the same view, said at least one memory stored with code thereon, which when executed by said at least one processor, further causes the apparatus to perform at least one of:
selecting a decoding tool which uses inter-component dependency from the depth view component to the texture view component;
encoding an indication of the selected decoding tool; and
receiving the depth view component in a base layer and receiving the texture view component in an enhancement layer.

21. The apparatus according to claim 19, wherein the depth view component of a view succeeds in access unit view component order the texture view component of the same view, said at least one memory stored with code thereon, which when executed by said at least one processor, further causes the apparatus to perform at least one of:
selecting a decoding tool which uses inter-component dependency from the texture view component to the depth view component; and
decoding a second indication indicative of the selected decoding tool; and
receiving the depth view component in a base layer and receiving the texture view component in an enhancement layer.

22. An apparatus comprising:
means for receiving at least one encoded view component of a first type and at least one encoded view component of a second type;
means for receiving at least one encoded indication of a view component order of the at least one view component of the first type and the at least one view component of the second type; and
means for decoding the at least one encoded indication of the view component order; and
means for adapting decoding of one or both of the at least one view component of the first type and the at least one view component of the second type on the basis of the view component order, wherein said means for adapting comprises means for selecting at least one of the following for decoding:
a decoding tool among a set of decoding tools;
a decoding mode among a set of decoding modes;
one or more decoding parameters.
